(19) United States
(12) Patent Application Publication
(10) Pub. No.: US 2026/0064943 A1
(43) Pub. Date: Mar. 5, 2026

(54) Systems and Methods for Data Storytelling Through Bidirectional Visualization and Text Generation

(71) Applicant: Salesforce, Inc., San Francisco, CA (US)

(72) Inventors: Yu FU, Atlanta, GA (US); Dennis Nathan BROMLEY, Seattle, WA (US); Vidya Raghavan SETLUR, Portola Valley, CA (US)

(21) Appl. No.: 19/010,863

(22) Filed: Jan. 6, 2025

Related U.S. Application Data
(60) Provisional application No. 63/691,282, filed on Sep. 5, 2024.
(60) Provisional application No. 63/693,864, filed on Sep. 12, 2024.

(51) Int. Cl. G06F 40/166; G06F 3/0482; G06F 40/40; G06T 11/20

(52) U.S. Cl. CPC G06F 40/166; G06F 3/0482; G06F 40/40; G06T 11/26; G06T 2200/24

(57) ABSTRACT

A computing device displays, on a user interface, a first visualization node and a text node. The first visualization node is upstream of the text node and includes a chart. In response to receiving a first user interaction with a portion of text content that is displayed in the text node, the device retrieving data of the first visualization node and transmits to a language model a first request that includes the data and the portion of text content. The device receives from the language model suggestions and data visualizations for analyzing the one or more datasets. The device displays the plurality of suggestions and their corresponding data visualizations on the user interface. The device receives user selection of a first suggestion that includes a first data visualization and renders a second visualization node on the user interface. The device displays the first data visualization in the second visualization node.

### RELATED APPLICATIONS

This application claims priority to (i) U.S. Provisional Patent Application No. 63/691,282, filed Sep. 5, 2024, titled “Systems and Methods for Visual Data Story Composition Through Bidirectional Chart-Text Generation” and (ii) U.S. Provisional Patent Application No. 63/693,864, filed Sep. 12, 2024, titled “DataWeaver: Authoring Data-Driven Narratives Through Bidirectional Visualization and Text Composition,” each of which is incorporated by reference herein in its entirety.

This application is related to U.S. Patent Application No. ______ (Attorney Docket Number 061127-5370-US), filed ______, titled “Systems and Methods for Authoring Data-Driven Narratives Through Bidirectional Visualization and Text Generation,” which is incorporated by reference herein in its entirety.

### TECHNICAL FIELD

The disclosed embodiments relate generally to data analysis, and more specifically to systems, methods, and user interfaces for generating interactive textual and visual data stories.

### BACKGROUND

Data storytelling is a data-driven process where stories are crafted around data and communicated to audiences to enable them to understand the significance of the data in a relatable and engaging way.

### SUMMARY

Data-driven storytelling is a technique that integrates data visualization with narrative techniques. Data-driven storytelling involves transforming raw data into compelling, often interactive narrative visualizations to convey complex data insights in a more digestible and engaging manner and is an effective approach for communicating data as it bridges the gap between the vast amounts of data available and the public's need to be informed and engaged. While media outlets were among the early adopters of data-driven storytelling, this practice has since expanded beyond journalism and is now utilized in areas such as business intelligence, marketing, and sports.

Creating data-driven stories is a multifaceted, interdisciplinary challenge that requires expertise in data analysis, visualization design and creation, and narrative writing. It can also include steps such as data cleaning and crafting visualizations based on the data. This complexity often makes it difficult for individuals to manage independently, demanding collaboration among various contributors through an intricate, iterative process, and is typically handled by major media platforms or individuals with advanced technical proficiency.

To lower these barriers and democratize data communication, prior work has introduced tools and methodologies aimed at simplifying the tasks and streamlining the process. However, the heterogeneity in roles, skill sets, and resulting artifacts often leads to fragmented workflows, hindering an integrated authoring experience.

A significant technical challenge associated with creating data-driven stories pertains to the composition of data-driven narratives—a process that is often time-consuming and error-prone, requiring authors to manually transcribe numerical data and insights into textual data facts and weave them into coherent, compelling narratives. Large language models (LLMs), with their advanced text generation capabilities, offer a promising solution for narrative composition by automatically generating textual narratives from data or visualizations. However, data-driven narratives are inherently complex, requiring precise alignment between the generated text and the underlying data or corresponding visualizations. While automated insight tools can considerably enhance the efficiency of producing data facts, they often rely heavily on significance scores to determine what is “interesting,” potentially limiting human agency and creativity in the storytelling process.

Recent progress in natural language interface research has led to the creation of several natural language-driven data interaction tools that allow users to query and manipulate data using natural language. Although these tools can facilitate the initiation of data-explicating writing processes using natural language (e.g., from text to visualization), current visual data storytelling processes predominantly start with data analysis or data visualization, meaning that there is a presumptive one-way path from data to story, which is from visualization to text. This inherent lack of bidirectionality (e.g., form text to visualization) can discourage text-first authors from adopting a data-driven approach. Even for experienced data storytellers, this data/story segmentation forces authors to constantly switch contexts between data analysis, visualization creation, and narrative composition, leading to potentially disjointed and inefficient workflows.

Some embodiments of the present disclosure address the deficiencies above in the development and implementation of data authoring tool that supports both visualization- and text-driven data storytelling through bidirectional generation of text and charts (i.e., text-to-visualization and visualization-to-text). The disclosed tool (e.g., system and user interface), also known as “DataWeaver,” enables authors to initiate data journalism process by either exploring a set of visualizations or composing narrative text. As disclosed, in some embodiments, Data Weaver features a flow-based, zoomable user interface that facilitates navigation between visualizations and narratives. Author interactions (user interactions) with visual elements of interest on a data visualization prompts a language model (e.g., a Large Language Model (LLM)) to generate relevant narratives based on these “call-out” interactions and intent-based data facts. Conversely, user interactions with text narratives can trigger the generation of relevant visualizations and recommendations. The interactive story elements can then be exported into a cohesive, reader-friendly data story.

As disclosed, in some embodiments, DataWeaver creates a mixed-mode data-article authoring environment that integrates data, analysis, visualization, and narrative writing within a single tool. This leads to a more fluid and efficient user experience for crafting visual data stories.

In some embodiments, DataWeaver leverages LLMs as a data-narrative engine for supporting “data-first” authors in constructing narrative text with appropriate visualizations. In some embodiments, DataWeaver applies a narrative-to-visualization pipeline for “text-first” authors in constructing relevant visualizations based on narratives and/or data flowing into the narratives. In some embodiments, Data Weaver incorporates deictic referencing through chart interactions, allowing users to highlight specific visual elements and anchor text generation to selected data facts. In some embodiments, DataWeaver supports a text-driven workflow through text-to-viz generation, which recommends and creates interactive visualizations based on selected text. In some embodiments, DataWeaver features a flow-based interface and additional functionalities, allowing users to seamlessly navigate the components and transform story elements into compelling, interactive presentations. In some embodiments, DataWeaver supports bidirectional workflows (e.g., text to viz, and viz to text) while maintaining a fluid authoring experience. In some embodiments, DataWeaver allows authors to transition freely between data exploration and narrative authoring.

In some embodiments, DataWeaver employs callout data facts to anchor the generated narrative to deterministic analyses. Advantageously, this feature diminishes accuracy issues such as hallucinations concerning LLMs and improves the functioning of the computer system and the application of LLMs to generate data narratives. As disclosed, in some embodiments, DataWeaver enables LLM-based tone control and manual text editing to support the author's narrative voice. Accordingly, in some embodiments as disclosed, Data Weaver assists authors in composing accurate and intended data narratives more efficiently.

The systems, methods, and user interfaces of this disclosure each have several innovative aspects, no single one of which is solely responsible for the desirable attributes disclosed herein.

In accordance with some embodiments, a method of generating data narratives is performed at a computing device that includes a display, one or more processors, and memory. The method includes displaying, on a user interface, a plurality of nodes associated with one or more datasets. The plurality of nodes includes a first visualization node and a second node that is connected to the first visualization node by a connector. The first visualization node includes a chart. The method incudes receiving a user interaction with a portion of the chart that is displayed in the first visualization node. The method includes, in response to receiving the user interaction: generating intermediate data according to the portion of the chart and displaying the intermediate data on the user interface. The method includes receiving, via the user interface, user selection of at least a subset of the intermediate data. The method includes, in response to receiving the user selection, transmitting to a language model a request based on the user selection of the at least the subset of the intermediate data and receiving, from the language model, data describing the one or more datasets according to the subset of the intermediate data selected by the user. The method includes rendering the data describing the one or more datasets as (i) an update or modification of the first visualization node or the second node, or (ii) a third node that is distinct from the plurality of nodes.

In some embodiments, the method includes, in response to receiving the user interaction with the portion of the chart that is displayed in the first visualization node, retrieving data metadata corresponding to the portion of the chart, including: (i) field names of data fields of the one or more datasets that are included in the portion of the chart; (ii) a data type corresponding to each of the data fields; and (iii) data values of the data fields that are included in the portion of the chart.

In some embodiments, the method includes, in response to receiving the user interaction with the portion of the chart that is displayed in the first node, retrieving chart metadata corresponding to the portion of the chart, including: (i) a chart type of the chart; (ii) visual encodings of the chart; and (iii) a variable in one or more tooltips of the chart.

In some embodiments, the method includes, in response to receiving the user interaction with the portion of the chart that is displayed in the first node, retrieving interaction metadata corresponding to the user interaction, including: (i) starting and ending coordinates of the chart specified by the user interaction; or (ii) starting and ending data values of the chart specified by the user interaction; or (iii) starting and ending date/times of the chart specified by the user interaction; or (iv) data points or data ranges specified by the user interaction.

In some embodiments, the second node is a text node and the data describing the one or more datasets comprises a text narrative.

In accordance with some embodiments, a method of generating data narratives, performed at a computing device that includes a display, one or more processors, and memory. The method includes displaying, on a user interface, a first visualization node and a text node associated with one or more datasets. The first visualization node is upstream of the text node and includes a chart. The method includes receiving a user interaction with a portion of text content that is displayed in the text node. The method includes, in response to receiving the user interaction: (i) retrieving data from the one or more datasets of the first visualization node; (ii) transmitting to a language model a first request that includes the data and the portion of text content; (iii) receiving from the language model a plurality of suggestions and a plurality of visualizations for analyzing the one or more datasets, each of the suggestions corresponding to one respective visualization; and (iv) displaying the plurality of suggestions and their corresponding visualizations on the user interface. The method includes receiving user selection of a first suggestion that includes a first visualization. The method also includes, in response to receiving the user selection: generating and rendering a second visualization node on the user interface, including displaying the first visualization in the second visualization node.

In some embodiments, the method includes, after displaying the first visualization in the second visualization node, receiving a user interaction with a portion of the first visualization that is displayed in the second visualization node. The method includes, in response to receiving the user interaction: generating intermediate data according to the portion of the first visualization and displaying the intermediate data on the user interface. The method includes receiving, via the user interface, user selection of at least a subset of the intermediate data. The method includes, in response to receiving the user selection: (i) transmitting to the language model a second request based on the user selection of the at least the subset of the intermediate data; and (ii) receiving, from the language model, data describing the one or more datasets according to the subset of the intermediate data selected by the user. The method also includes rendering the data as an update to the text node.

In accordance with some embodiments, a computing device includes a display, one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing device having a display, one or more processors, and memory. The one or more programs include instructions for performing any of the methods disclosed herein.

Thus methods, systems, and graphical user interfaces are disclosed that generate interactive textual and visual data stories.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIGS. 1A to 1C illustrate a user interface for supporting bidirectional data story authoring, in accordance with some embodiments.

FIG. 1D illustrates a process for bidirectional generation of interactive visualizations and text narratives, in accordance with some embodiments.

FIG. 1E illustrates a visualization-to-text composition workflow, in accordance with some embodiments.

FIG. 1F illustrates a text-to-visualization composition workflow, in accordance with some embodiments.

FIG. 2 provides a block diagram of a computing device, in accordance with some embodiments.

FIG. 3 provides a block diagram of a server system, in accordance with some embodiments.

FIGS. 4A and 4B illustrate a callout intent framework, in accordance with some embodiments.

FIG. 4C illustrates example data facts generated by Data Weaver in response to detecting a user interaction comprising brushing over a region of a scatterplot, in accordance with some embodiments.

FIG. 4D illustrates in-list sorting mechanisms for data facts in DataWeaver, in accordance with some embodiments.

FIGS. 5A to 5G are screenshots illustrating the generation of text narratives from visualization nodes, in accordance with some embodiments.

FIGS. 6A to 6D illustrate affordances of a text node for modifying a generated data narrative, in accordance with some embodiments.

FIGS. 7A to 7C are screenshots illustrating the generation of visualization content from text nodes, in accordance with some embodiments.

FIGS. 8A to 8C are screenshots illustrating the review capabilities of Data Weaver in accordance with some embodiments.

FIGS. 9A to 9E provide a flowchart of a method for generating data narratives, in accordance with some embodiments.

FIGS. 10A to 10E provide a flowchart of a method for generating data narratives, in accordance with some embodiments.

FIG. 11A illustrates a visualization-to-text prompt template corresponding to a prompt generated by a computing device, in accordance with some embodiments.

FIGS. 11B-1 and 11B-2 illustrate a visualization-to-text prompt template for chart-specific prompts generated by a computing device, in accordance with some embodiments.

FIG. 12A illustrates a text-to-visualization prompt template corresponding to a prompt generated by a computing device, in accordance with some embodiments.

FIG. 12B illustrates a text-to-visualization prompt template corresponding to a prompt generated by a computing device, in accordance with some embodiments.

FIGS. 12C-1 to 12C-6 illustrate templates for various chart specifications, corresponding to one or more prompts generated by a computing device, in accordance with some embodiments.

FIG. 12D explains each placeholder used in the prompt templates and chart specifications, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

Some embodiments of the present disclosure are directed to DataWeaver, a visual data story authoring tool that enables bidirectional composition of data narratives and visualizations. As disclosed, Data Weaver supports visualization-to-text composition by incorporating deictic referencing through chart interactions, allowing users to highlight specific visual elements and anchor text generation to selected data facts. DataWeaver also supports a text-driven workflow through text-to-visualization generation, which recommends and creates interactive visualizations based on selected text. Additionally, the system features a flow-based interface and additional functionalities, allowing users to seamlessly navigate the components and transform story elements into compelling, interactive presentations.

In accordance with some embodiments of the present disclosure, a computing device (e.g., executing DataWeaver) displays, on a user interface, a plurality of nodes associated with one or more datasets. The plurality of nodes includes a first visualization node and a second node that is connected to the first visualization node by a connector (e.g., an edge). In some embodiments, the second node is a text node. In some embodiments, the second node is a visualization node that is different from the first visualization node. The first visualization node includes a chart (e.g., a data visualization). In some embodiments, the first visualization node displays a text table or a data dashboard that includes two or more visualizations. The computing device receives a user interaction with (e.g., user selection of) a portion of the chart that is displayed in the first visualization node. The computing device, in response to receiving the user interaction, generates intermediate data according to the portion of the chart and displays the intermediate data on the user interface. In some embodiments, the intermediate data comprises data facts. In some embodiments, the intermediate data comprises visualizations. The computing device receives, via the user interface, user selection of at least a subset of the intermediate data. The computing device, in response to receiving the user selection, transmits to a language model a request based on the user selection of the at least the subset of the intermediate data and receives, from the language model, data describing the one or more datasets according to the subset of the intermediate data. In some embodiments, the computing device renders the data describing the one or more datasets as an update or modification of the first visualization node or the second node. In some embodiments, the computing device renders the data describing the one or more datasets as a third node that is distinct from the plurality of nodes.

In accordance with some embodiments of the present disclosure, a computing device (e.g., executing DataWeaver) displays, on a user interface, a first visualization node and a text node associated with one or more datasets. The first visualization node is upstream of the text node (e.g., such that data flows from the upstream visualization node to the downstream text node) and includes a chart (the visualization node and the text node connected by a connector edge). The computing device receives a user interaction with a portion of text content that is displayed in the text node. The computing device, in response to receiving the user interaction, retrieves data from the one or more datasets of the first visualization node. The computing device transmits to a language model a first request that includes the data and the portion of text content and receives from the language model a plurality of suggestions and a plurality of visualizations for analyzing the one or more datasets. Each of the suggestions corresponds to one respective visualization. The computing device displays the plurality of suggestions and their corresponding visualizations on the user interface. The computing device receives user selection of a first suggestion that includes a first visualization. The computing device, in response to receiving the user selection, generates and renders a second visualization node on the user interface, including displaying the first visualization in the second visualization node.

Findings from Formative Study

To gain deeper insights into the challenges of data story composition and to inform the design and functionality, the inventors conducted a formative study that includes hands-on exercises and post-study interviews with expert practitioners. The findings identified from the study include:

Finding 1: Transcribing numbers from visualizations into text is a tedious and error-prone process. In some situations, getting some of the numbers from the visuals into text can be challenging, and requires the authors of the data story to go back and forth. In some instances, this issue can be particularly pronounced when values are not directly visible in the charts. Authors often need to hover over elements to reveal specific data points. For example, in a visualization displaying the score differences of a basketball game, while the chart clearly illustrates a change in score, the participant needed to retrieve the specific difference value (e.g., 25-point lead) to write an accurate narrative. This back-and-forth transition between the visual representation and the text field disrupts the writing flow and increases the likelihood of transcription errors.

Finding 2: Pre-calculated statistics and data facts for selected data points can facilitate the writing process. Participants of the study responded positively to the idea of pre-calculated data facts automatically generated from relevant data points as they interacted with visualizations. Advantageously, the availability of pre-calculated statistics and data facts can enhance the writing flow and reduce the likelihood of errors in data story composition.

Finding 3: Highlighting visual elements can be ambiguous and lead to varied narratives. Participants of the study often utilized chart interactions, such as clicking and brushing, to highlight visual elements of interest when the visualization affords such interactions. They also utilized annotation boxes afterward to further reinforce these highlights. However, the inventors observed that without accompanying text, it can be difficult to accurately interpret the intentions behind the highlights. For example, highlighting three data bars of a bar chart can lead to different insights, such as a pairwise comparison, highlighting specific ranks, or simply enumerating the values. This ambiguity can result in divergent narratives, making it challenging for a computer system to directly compose narratives that fully capture authors' intents.

Finding 4: The participants of the study strongly prefer AI to act as ‘assistants’ or ‘optimizers’ rather than as sole ‘creators’ in writing data narratives. When participants were asked about their preferred roles for AI in this process, both Assistant and Optimizer roles earned four votes, followed by Reviewer with three votes. The Creator role received only one vote, contingent on the condition that “only when it is good enough.” Accuracy emerged as the most frequent concern when using AI to directly generate narratives. Additionally, some participants also have concerns around data security and are reluctant to input raw data directly into AI systems.

### Data Weaver Design Goals

In accordance with some embodiments of the present disclosure, the design goals for DataWeaver and implementations to realize the respective design goals include:

Design Goal 1: Facilitating Data-Driven Narrative Composition. As disclosed, one of the design goals for Data Weaver is to streamline the composition of data-driven narratives that accurately reflect the authors' intentions and the underlying data. While language models (e.g., LLMs) excel at generating text, the creation of data-driven narratives requires more than just linguistic capability—it demands precise data aggregation, accurate calculations, and alignment with both the data and its visual representations. The current limitations of language models include restricted context length, limited numerical precision, and challenges in processing complex data, which hinder their ability to transform raw data directly into narratives that truly align with users' intentions and the underlying data.

In some embodiments, to address these challenges and leverage the strengths of LLMs, Data Weaver is configured to enable users to specify and highlight visual elements of interest using chart interactions. Some embodiments allow authors to specify and highlight the data points they wish to “write about” through direct interactions with charts. User interactions with visualizations can support visual analytics and enable data analysts to “dive in” and “explore” the broader dataset. Some embodiments employ chart interactions for deictic referencing, allowing selection and highlighting to signal both to machines and audiences that “these” elements are the focal point of the discussion. While other types of interactions, such as sketching, are also used for similar purposes, some embodiments implement chart interactions (e.g., clicking and brushing) due to their selection precision, strong support in visualization tools like D3.js, and alignment with users' familiarity.

In some embodiments, to achieve Design Goal 1, DataWeaver is configured to compute descriptive statistics and data facts for highlighted data points. Some embodiments propose introducing an intermediate data fact layer between users' interactions and narrative generation. In some embodiments, this layer serves several purposes, including: (1) ensuring accurate and expedited computation by delegating the computational load to machines rather than LLMs; (2) allowing users to pick the most relevant data facts, thereby enhancing the relevance of the output; and (3) anchoring the generated narratives to a well-defined set of data facts, thus reducing hallucinations by AI models and improving overall accuracy.

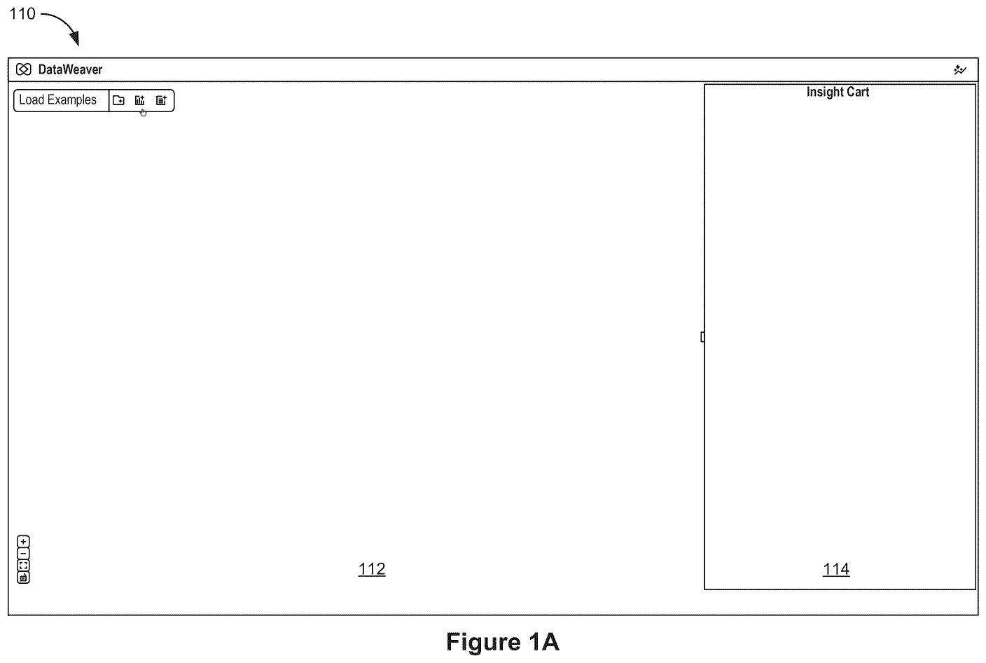

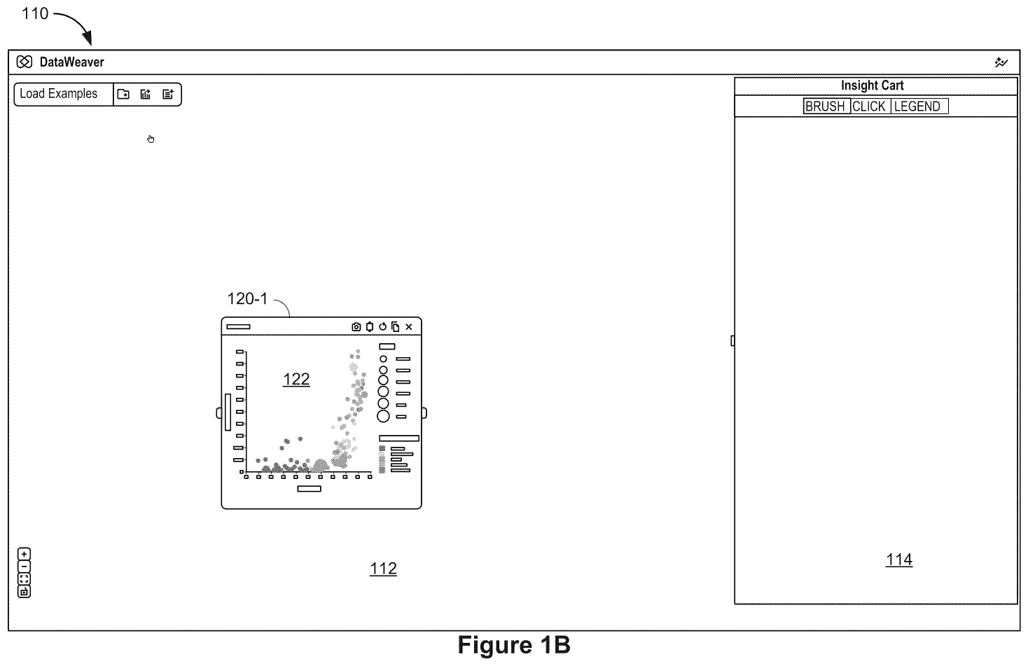

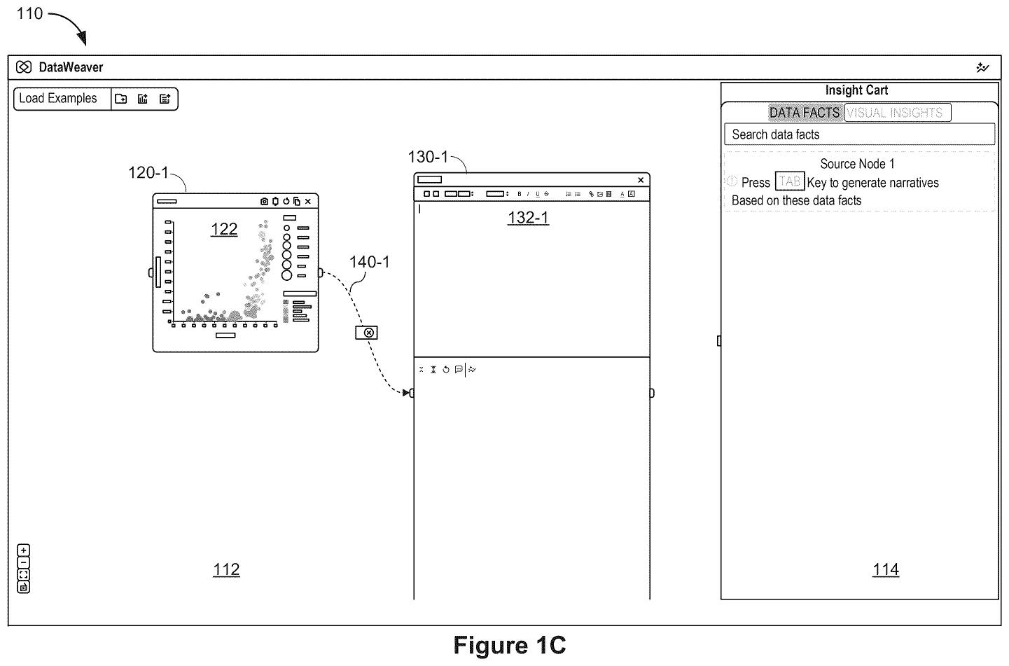

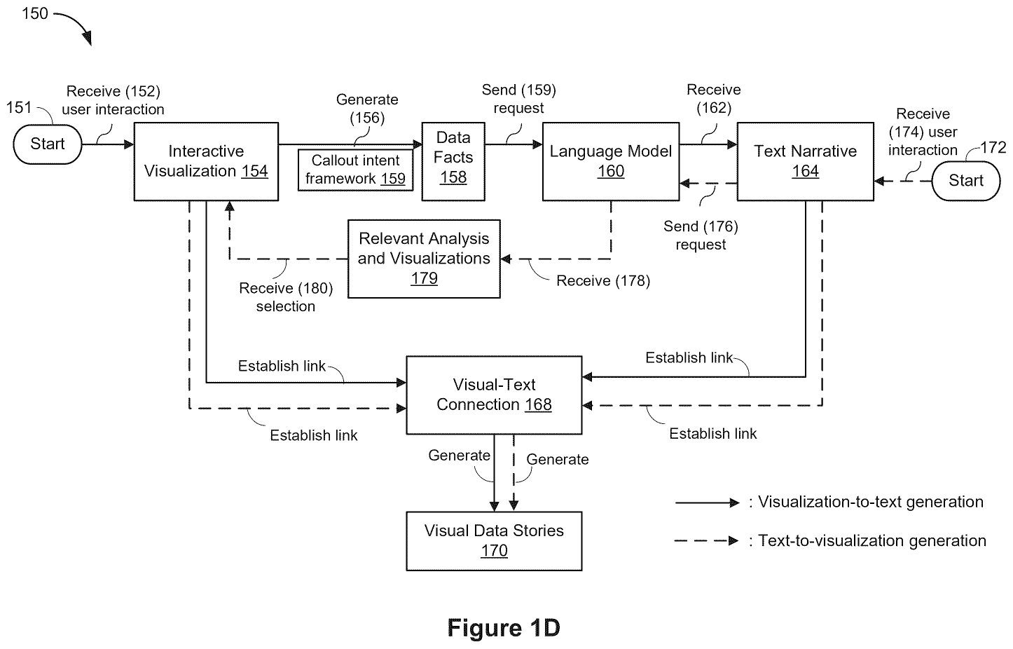

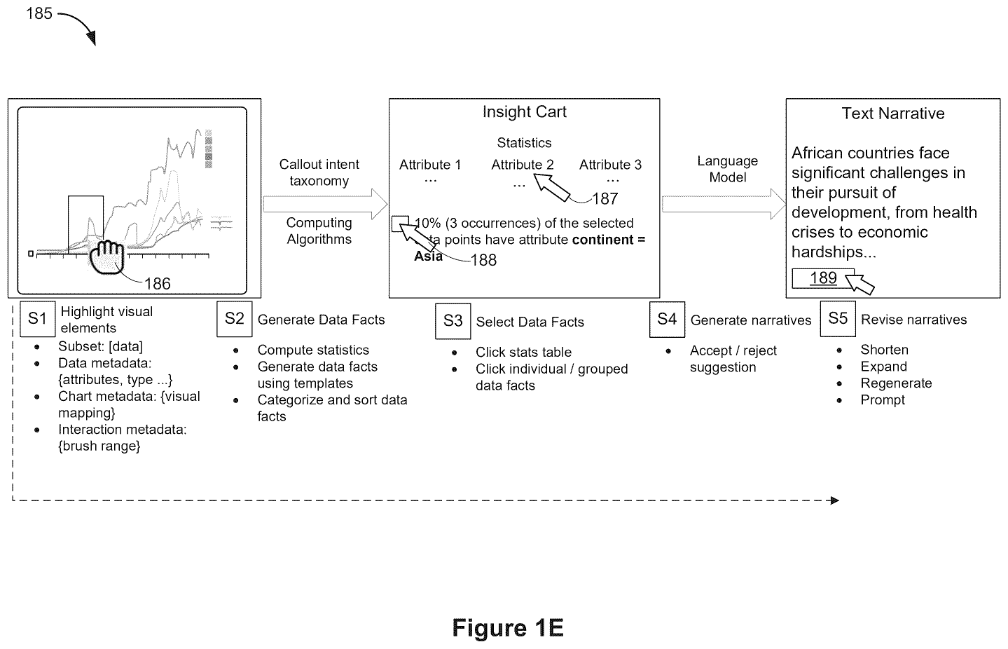

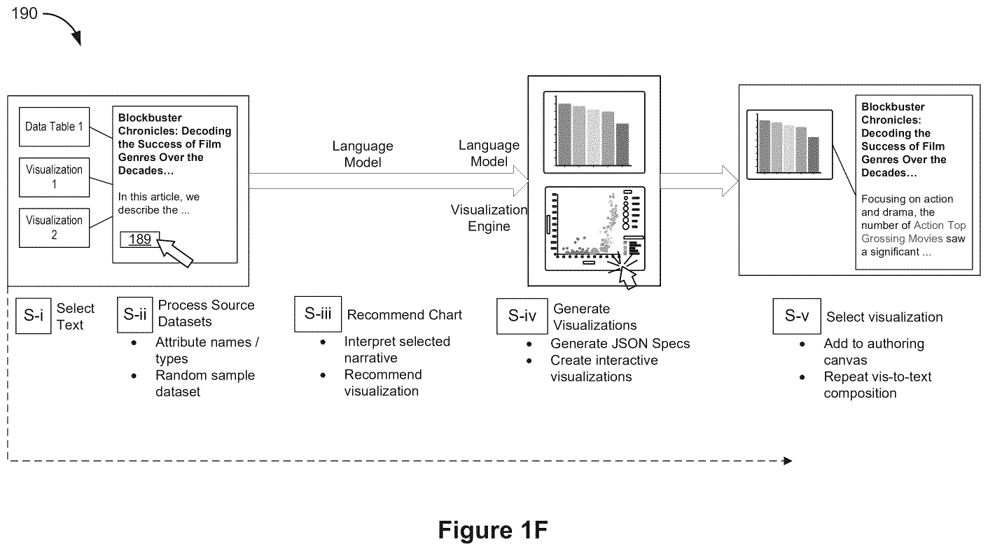

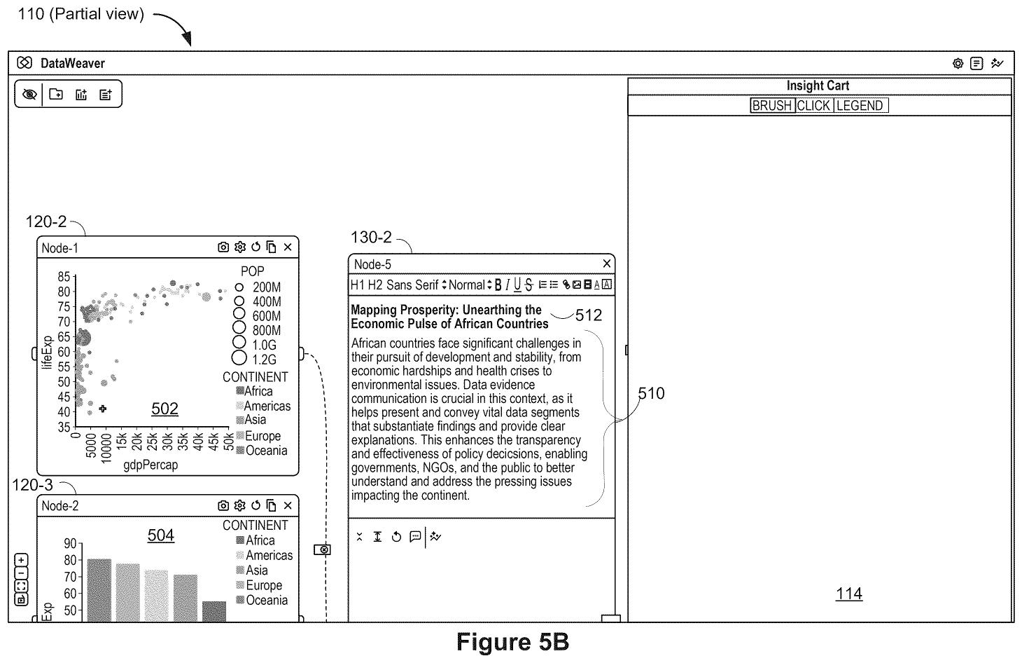

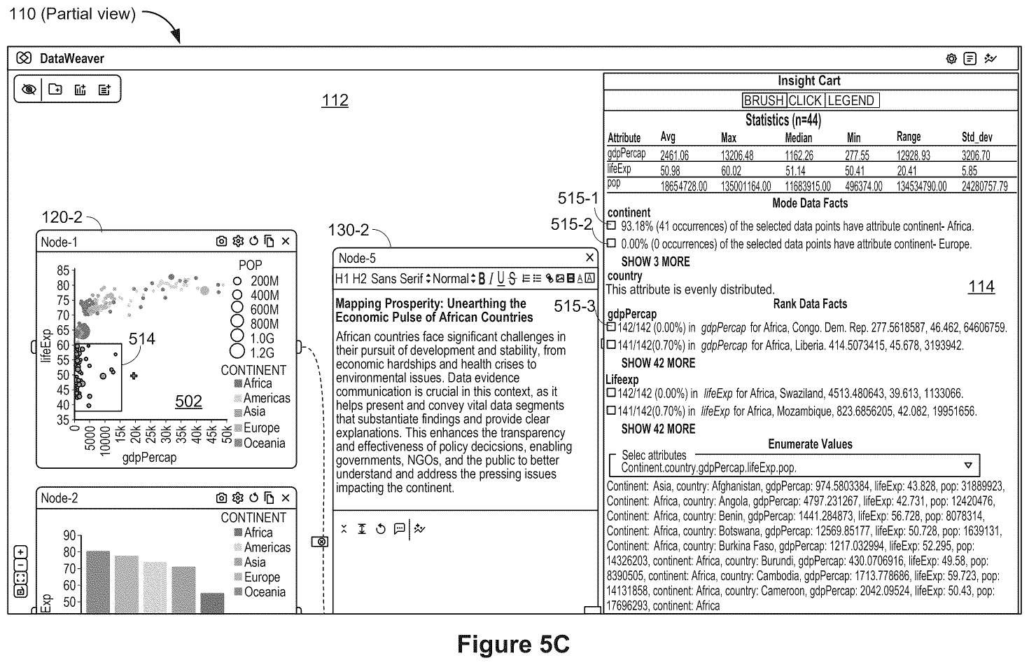

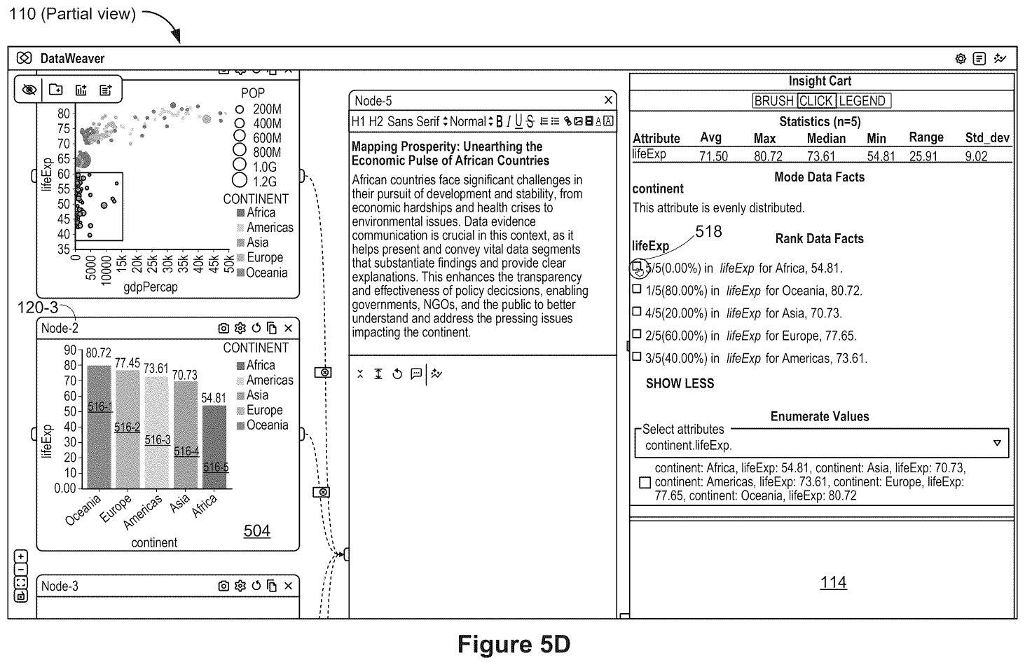

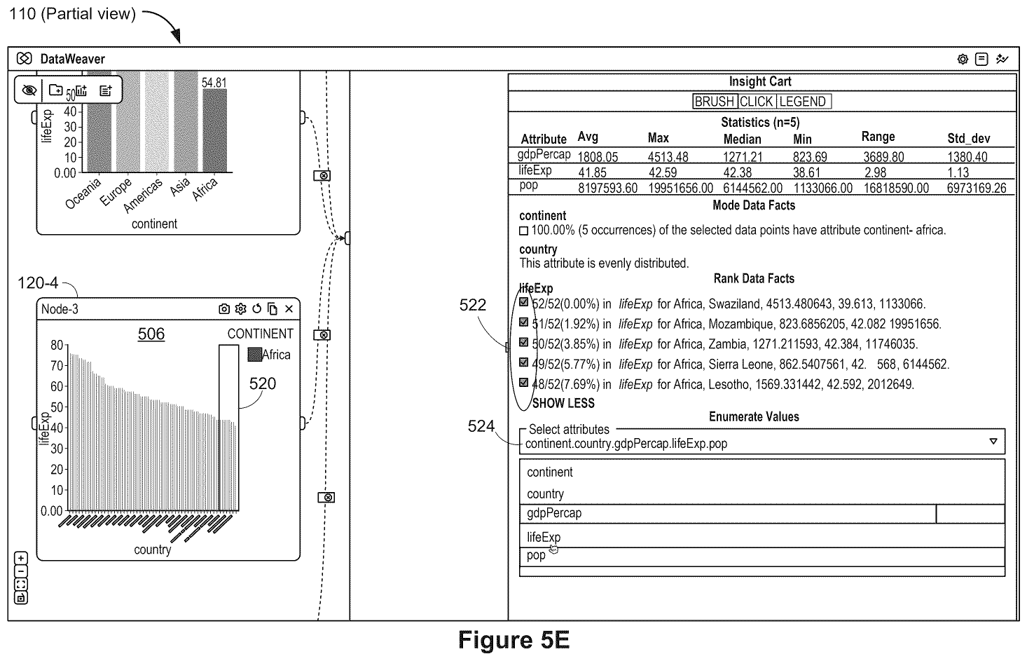

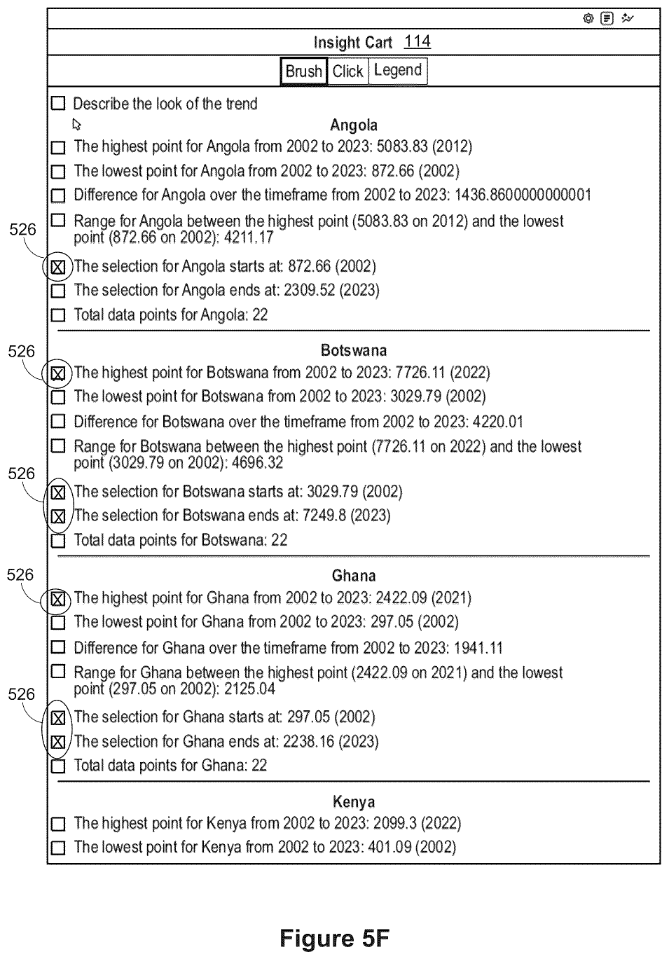

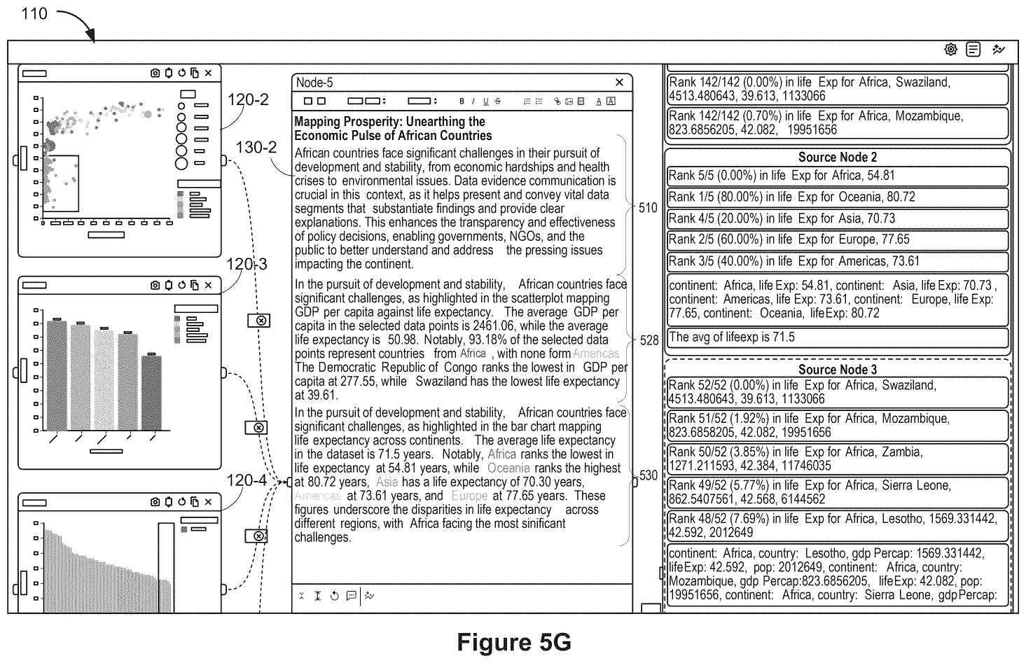

In some embodiments, to achieve Design Goal 1, DataWeaver is configured to utilize LLMs to generate data narratives anchored to user-selected data facts. In some embodiments, DataWeaver is configured to apply LLMs to weave the chosen data facts into coherent and compelling narratives, harnessing their linguistic power while ensuring that the generated content remains accurate, contextually relevant, and aligned with the user's intent. In some embodiments, DataWeaver includes text-editing controls sufficient to allow the user to control the tone, length, and writing style of the LLMs' generated text, as well as the ability to manually edit the raw text. In sum, by fulfilling these three requirements, Data Weaver enable users to discover insights in visualizations, highlight key data points, and generate corresponding narratives. In some embodiments, this process is also referred to as “visualization-to-text” composition, and is also described with reference to FIGS. 1D, 1E, and 5A to 5G.

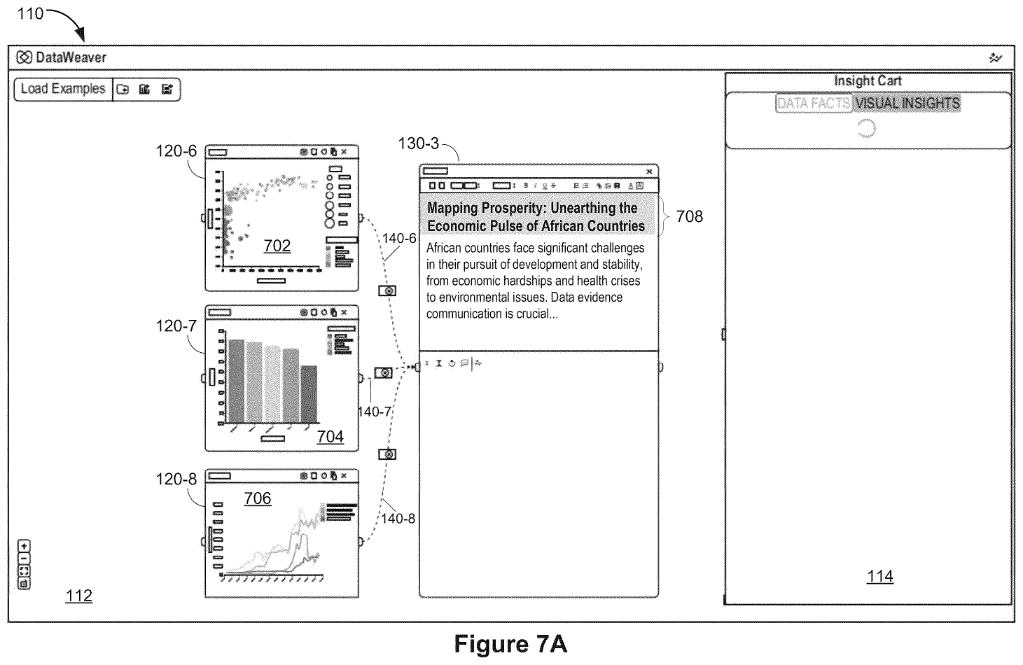

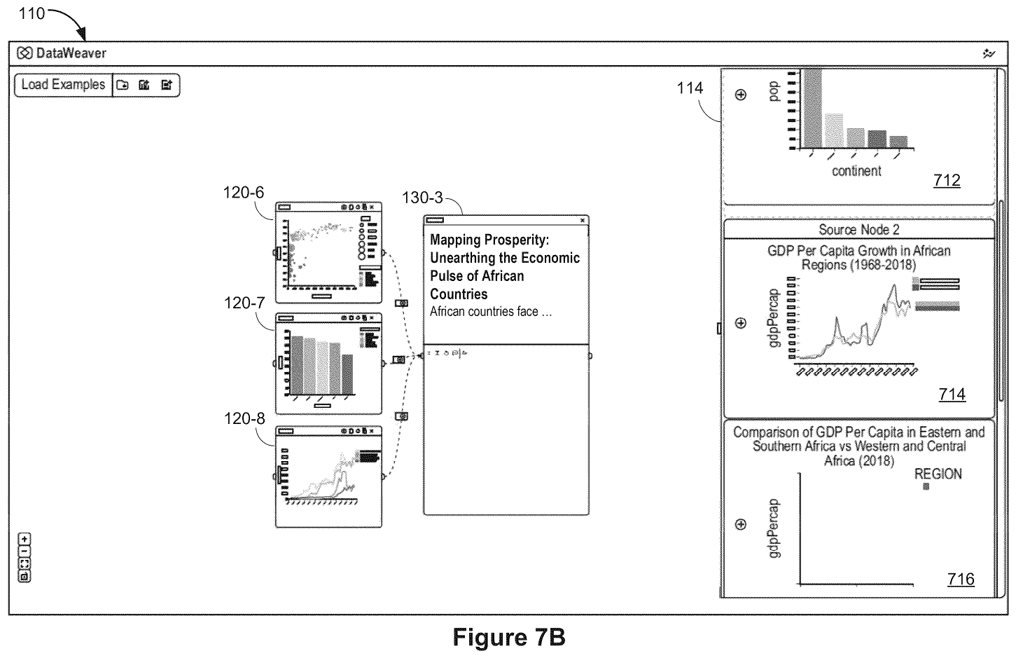

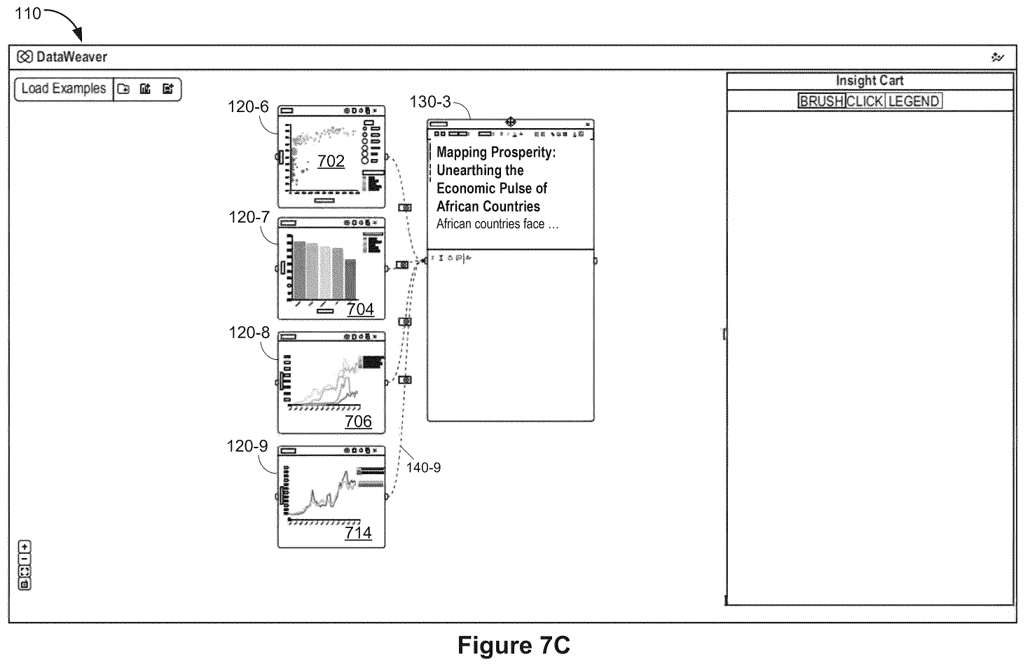

Design Goal 2: Enabling a Narrative-Initiated Data Storytelling Workflow. In accordance with some embodiments, DataWeaver empowers authors by offering text as an alternative starting point for creating data stories. This approach provides the flexibility to initiate the writing process with text, whether by drafting new narratives or expanding on existing ones. Recent advancements in natural language interface (NLI) research have introduced diverse NL-driven data interaction methods, enabling users to query, manipulate data, and author or interact with visualizations through natural language. Building on this work, some embodiments of Data Weaver include a “text-to-visualization” pathway that complements the aforementioned “visualization-to-text” composition, creating a bi-directional, ‘boomerang-like’ loop. “Visualization-to-text” composition is discussed with reference to FIGS. 1D, 1F, and 7A to 7C.

In some embodiments, to achieve Design Goal 2, DataWeaver is configured to recommend and generate interactive data visualizations relevant to user-selected narratives. In some instances, a significant obstacle in authoring data-driven stories is the need to perform data wrangling and create appropriate visualizations. In some embodiments, delegating these tasks to DataWeaver can jumpstart the authoring process and potentially relieve users with limited data expertise from the technical challenges that impede story creation. In some embodiments, DataWeaver is configured to take users' written narratives and enhance or expand them with additional visualizations. To achieve this, some embodiments leverage the semantic interpretation capabilities of LLMs to recommend relevant analyses and use it to generate chart specifications for the automatic creation of interactive visualizations.

Design Goal 3: Supporting the proposed bidirectional authoring process and creation of final presentations. In accordance with some embodiments, DataWeaver includes a user interface that effectively integrates the bidirectional workflows. Unlike regular text-dominant stories, where a “what you see is what you get” (WYSIWYG) editor often suffices, composing visual data stories is more intricate—it involves exploratory data analysis, creating visualizations and accompanying text, and specifying the links and interactions between them. Typically, this process begins with data analysis, and the interfaces designed to support it usually reflect this sequence.

In some embodiments, to support a bidirectional workflow, Data Weaver implements a flow-based authoring interface to support dynamic navigation between different components and story slices. Data-driven narratives tend to be more block-based, with narrative paragraphs connected to various charts or chart states. Additionally, the resulting stories can be multi-threaded, involving numerous visualizations, datasets, and narratives. In some embodiments, to create a more integrated and efficient experience, DataWeaver implements a flow-based interactive authoring workflow where users can add datasets, visualizations, and text as modular nodes with edge connections between them. Some embodiments introduce an “insight cart” component (e.g., insight cart 114) that functions as a “shopping cart” for data facts and insights that the user may wish to include in their narrative. This interconnected, three-part componentization of data, text, and visualization mirrors the authoring needs uncovered in the formative study, namely automatic number transcription (Finding 1), data-fact and insight management (Finding 1), and accurate conveyance of visualization-interactive intent (Finding 3) to the (Finding 4) final text narrative.

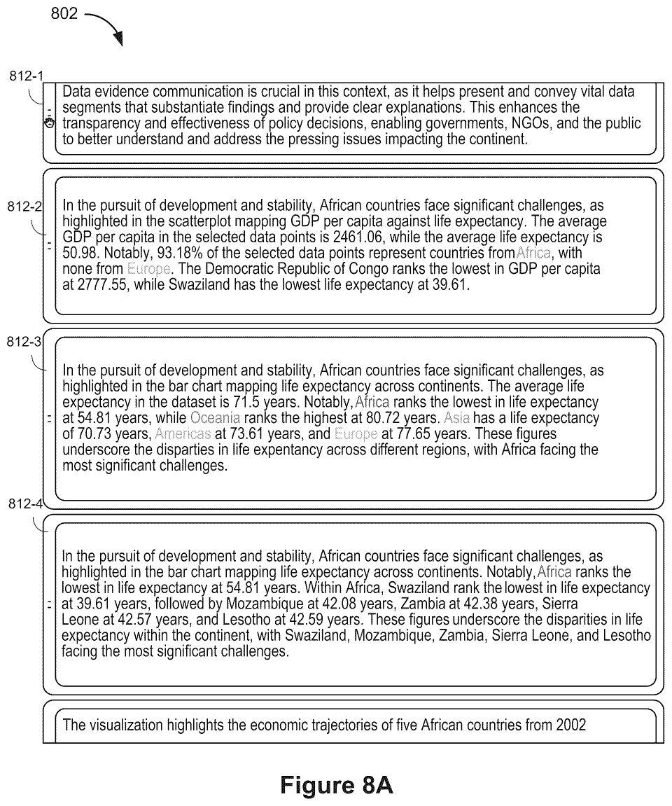

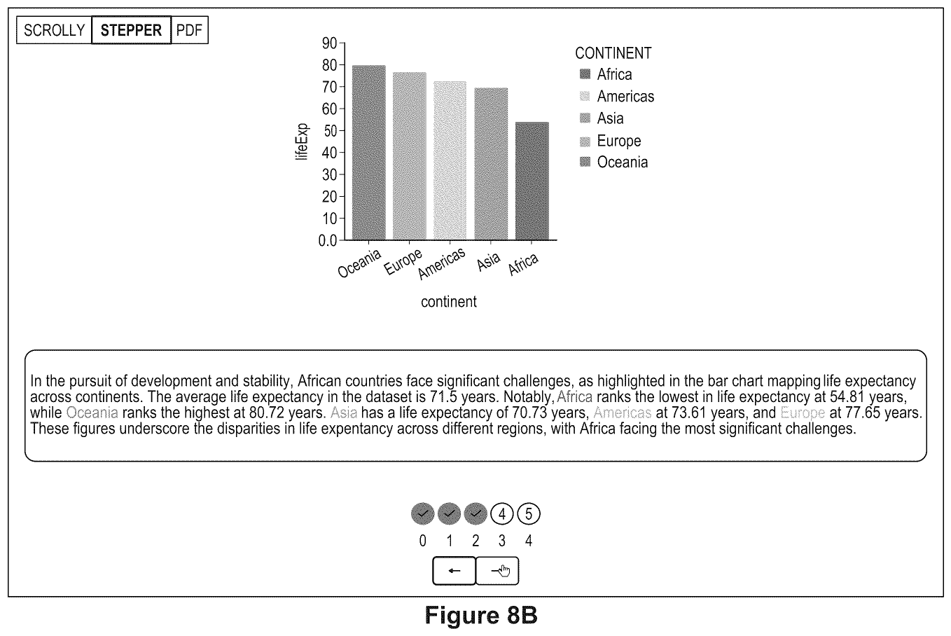

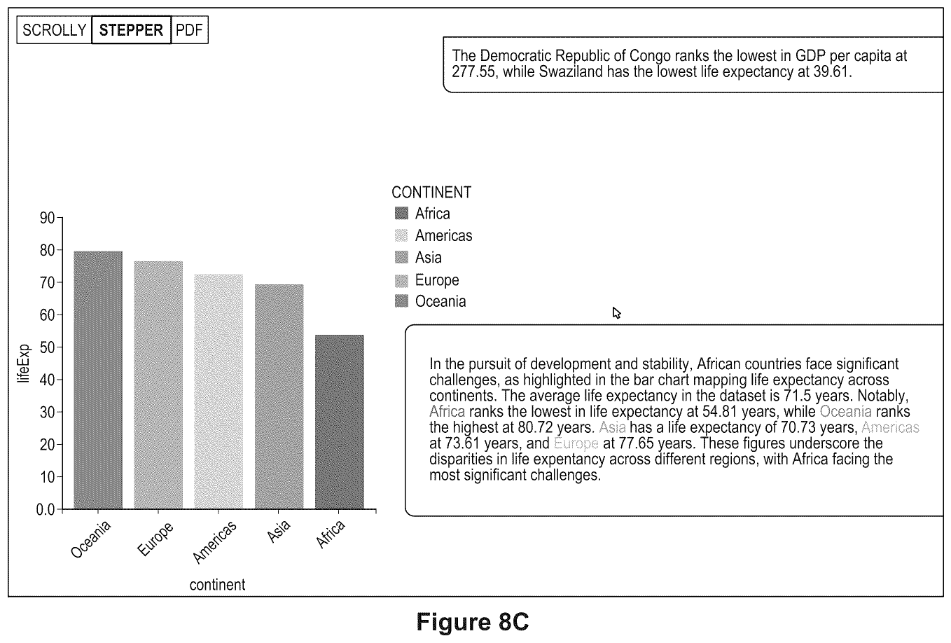

In some embodiments, to achieve Design Goal 3, DataWeaver leverages the visualization-text connections to enable flexible presentation formats. Another significant challenge involves transforming the composed story elements into compelling presentation artifacts. Authors can weave these story elements together using various storytelling techniques that provide explanatory guidance, leave space for readers to explore interactively, and enhance engagement with animated transitions. Some embodiments of DataWeaver include review capabilities that enable a user to reorder the story and convert the story pieces into different presentation formats. This is discussed in, for example, FIGS. 8A to 8C. Some embodiments envision that the vis-text connections established during story generation can be leveraged to streamline the process of story presentation.

### Callout Intent Taxonomy

Some embodiments disclose the development of a callout intent taxonomy for Data Weaver. In some embodiments, the callout intent taxonomy is a framework that guides the generation of more relevant data facts and their effective organization. In the present context, callout interactions refer to user actions that highlight specific data points in a visualization, callout intent refers to the motivation behind such highlights, and callout data facts are the insights derived from these interactions. As discussed in the previous section, one of the design goals for Data Weaver is to streamline the composition of data-driven narratives that accurately reflect the authors' intentions and the underlying data. To achieve this goal, a balance between providing users with granular control over defining “what's salient” and reducing their mental workload in selecting which data facts to use is needed. Accordingly, an effective approach to the computation and organization of data facts—a mechanism that disambiguates users' intents and generates a targeted list of data facts based on their interactions—is desired.

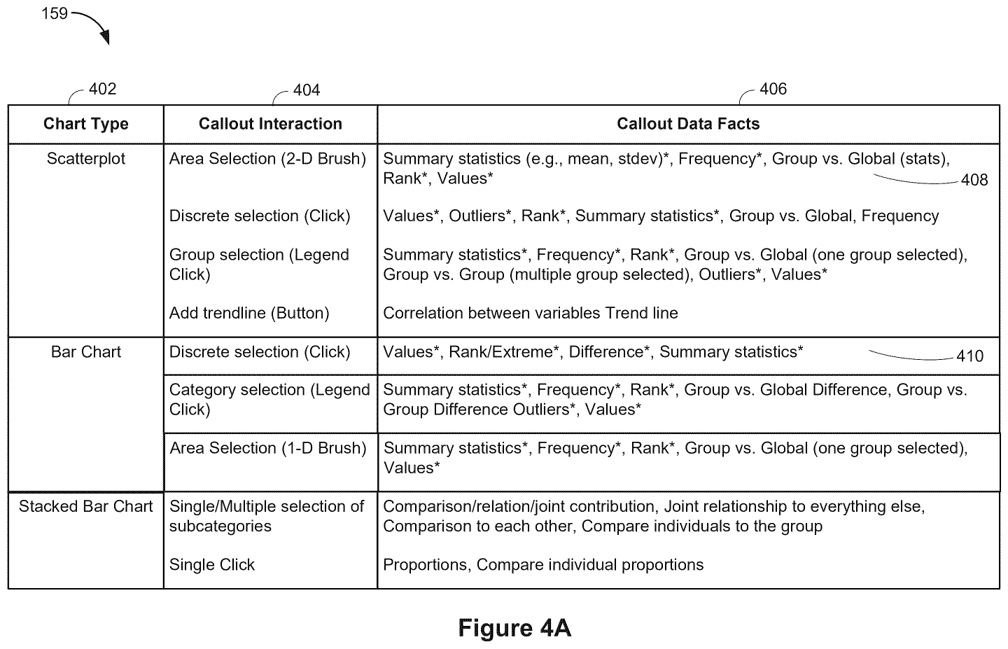

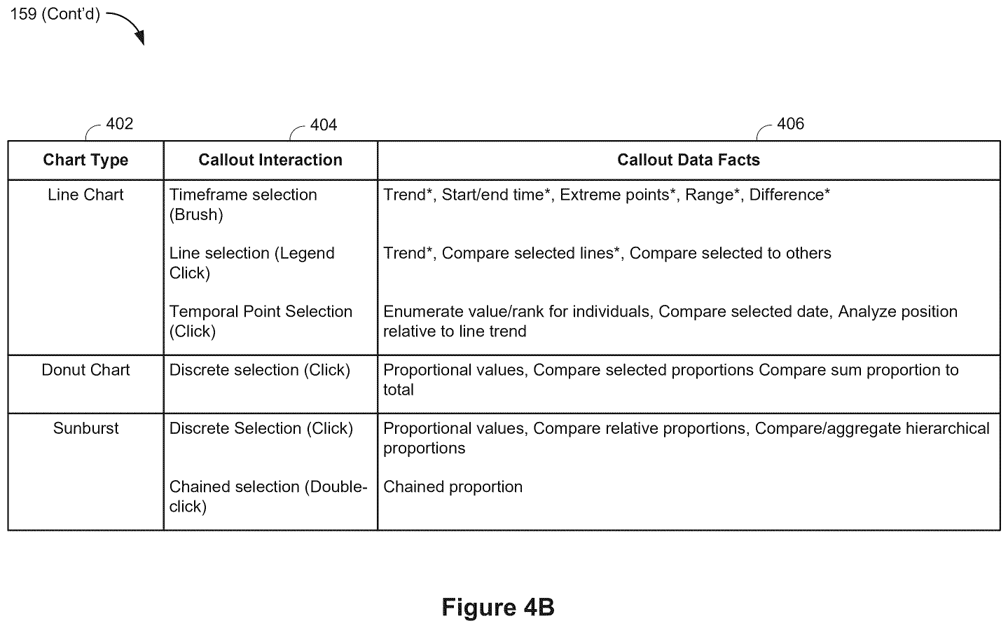

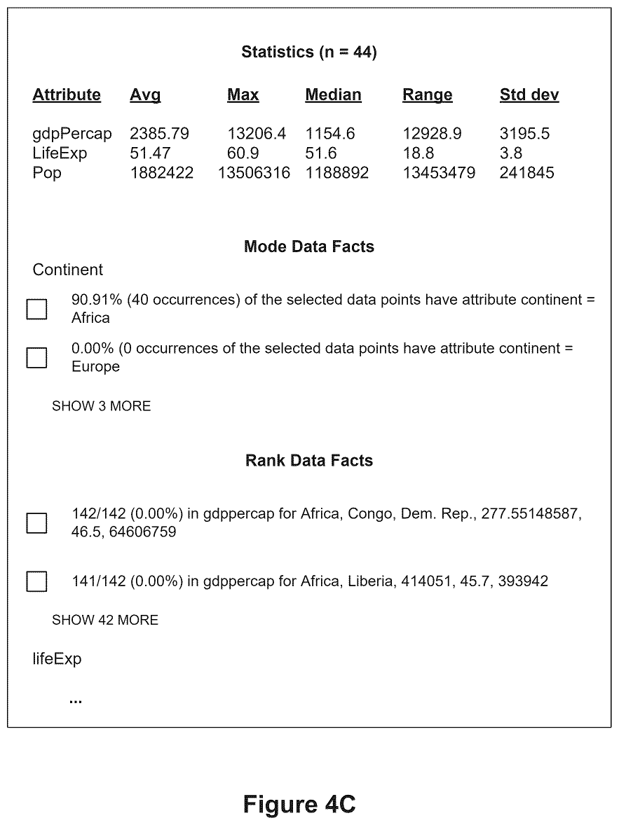

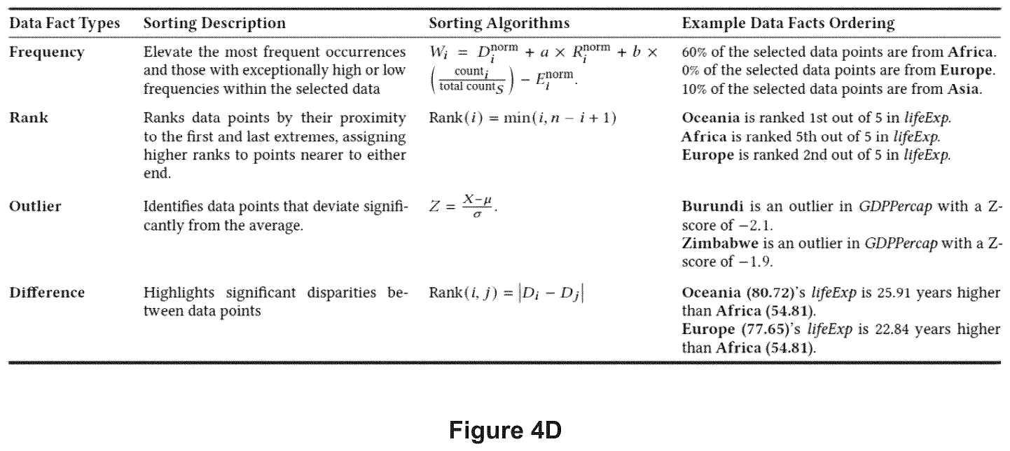

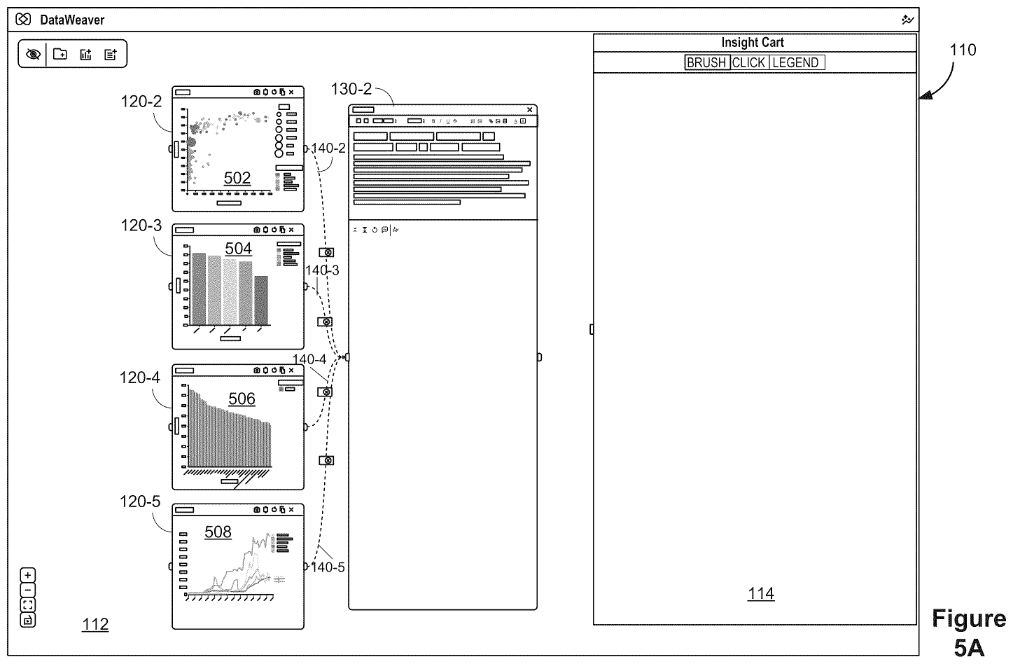

FIGS. 4A and 4B illustrate a taxonomy for callout intent in data visualizations, in accordance with some embodiments of the present disclosure. These figures outline various chart types and their corresponding callout interaction types along with the associated callout data facts. An asterisk (*) next to the data fact indicates that a data fact calculation is implemented in DataWeaver to generate the data fact.

To develop the taxonomy for callout intent, some embodiments include selecting a list of exemplary chart types, including standard charts (e.g., bar charts, scatterplots, line charts, and donut charts), and advanced charts, including stacked bar charts and sunburst charts. Next, a list of callout interactions, tailored to each chart type, is curated, drawing from the interactions supported by various visualization authoring tools and interactive visualization libraries. The callout data facts corresponding to each interaction are then developed, followed by iterative refinement of the merged list. Note that the taxonomy that is illustrated in FIGS. 4A and 4B are intended to be illustrative and can be expanded to accommodate additional chart types, callout interactions, or even compounded/chained callout interactions.

In accordance with some embodiments of the present disclosure, DataWeaver facilitates the composition of relevant and accurate data narratives via callout interactions, by providing tools that allow authors to easily annotate, select, and/or highlight specific interesting data points or insights gleaned from the authors' analysis of the data visualizations, which they would like to include in the text narrative. In some embodiments, Data Weaver determines (e.g., computes) a list of data facts and organizes them by their “interestingness,” heuristics, and users' potential callout intents. A user can select a subset of data facts to be included in the data narrative. In some embodiments, the data facts associated with the selected portions of the data visualization can be input into LLMs (e.g., language models or generative models) to generate data-driven narratives. In some embodiments as disclosed herein, the implementation of the taxonomy for callout intent improves the reliability of narratives generated by LLMs, by ensuring that the LLMs are consistent with the underlying data (i.e., no hallucination). In some embodiments, Data Weaver employs the capabilities of LLMs and large visual models (LVMs) by drawing information from their knowledge bases and applying them to recommend relevant analyses and/or generate visualizations based on users' focused text.

### Data Weaver User Interface

FIGS. 1A to 1C illustrate a user interface 110 for DataWeaver, a tool for supporting bidirectional data story authoring, in accordance with some embodiments. In some embodiments, the user interface 110 is a zoomable user interface that supports zooming in and out (e.g., magnifying or de-magnifying) through manipulation of graphical elements, widgets, and text.

FIG. 1A shows that the user interface 110 includes an authoring canvas 112 (e.g., a canvas region) for composing visualizations and text. The authoring canvas 112 is a flow-based interface that allows users (e.g., authors of data stories) to add nodes and edges. A node is a fundamental unit and represents a component (e.g., primary content component) of the data story. In some embodiments, DataWeaver supports two types of nodes, namely visualization nodes 120 (also known as “vis-nodes”) and text nodes 130 (also known as “text editor nodes”), which can be added to the user interface 110. A visualization node 120 includes an interactive data visualization (e.g., a chart) whereas a text editor node 130 includes an interactive text narrative. The visualization nodes 120 and the text nodes 130 correspond to the primary content components and are commonly found in real-world visual data stories.

In some embodiments, a respective visualization node 120 represents a Tableau analytical artifact such as a worksheet, a data dashboard, a data visualization, or a data table, and is associated with one or more respective data sources. In some embodiments, a user can add various types of interactive visualizations or data tables as visualization nodes 120. Upon creation of a visualization node, the user can upload and manipulate datasets (e.g., by applying one or more filters), select the chart type, and specify the attributes that determine the visual encodings of a chart. FIGS. 4A and 4B illustrate the chart types supported by Data Weaver in accordance with some embodiments. Visualization nodes 120 also allow a user to modify the settings (e.g., tooltip content) or reconfigure the visual mapping.

In some embodiments, a respective text node 130 can leverage Tableau dashboard's extension APIs, which allow for custom text input and editing within the Tableau dashboards. In some embodiments, the visualization nodes 120 and the text nodes 130 can utilize Tableau's data connection capability to bind different data sources. In some embodiments, a respective text node 130 can feature a rich text editor for composing narratives, as well as widgets for supporting additional functionalities, as will be described in further detail below.

In some embodiments, a user can establish a connection between two nodes using a connector 140 (e.g., an edge). A connector 140 specifies the content generation flow between two connected nodes (e.g., or from one node to the other node). For example, FIG. 1B illustrates a visualization node 120-1, corresponding to data visualization 122 (e.g., a scatter plot), that is generated and displayed on the user interface 110. FIG. 1C illustrates generation and display of a text node 130-1 on the user interface 110. In FIG. 1C, the visualization node 120-1 and the text node 130-1 are connected via connector 140-1. Additionally, users can move, resize, duplicate, or remove nodes from the canvas.

In some embodiments, visualization-to-text connectors specify the flow of data facts generated by chart interactions. For example, if visualization node A and visualization node B both have connectors directed to text node C, the data facts provided by these two visualization nodes will collectively contribute to the text node. A user can also reuse the data facts for different text nodes. This mechanism aims to assist users in managing story content and flow, especially when composing a multi-thread data story that involves multiple sets of data facts and visualizations.

In some embodiments, the dataset(s) bound to visualization nodes automatically serve as the source data for visualization recommendations. Similarly, in some embodiments, a user can elect to present the datasets as data tables without causing a chart to be rendered. Visualization-to-visualization connectors connect multiple visualizations, enabling a user to create multi-view dashboards. Text-to-text connects can help set the order of text content and use the text in the predecessor node as context for text generation in the successor node.

With continued reference to FIG. 1A, in some embodiments, the user interface 110 includes an insight cart 114 (e.g., an insight cart region). The insight cart, like a “shopping” cart, serves as a temporary repository to store insights for “checkout,” i.e., integration into a data story. In some embodiments, the “items” in the insight cart 114 can include data facts generated by chart interactions or visualizations rendered based on the written narratives.

In some embodiments, a respective node (e.g., a text node or a visualization node) has its own insight cart. In some embodiments, an insight cart of a respective visualization node can include insights drawn from a chart's user-selected data, including a statistical table and data facts generated based on a user's callout interactions with the visualization node. In some embodiments, the contents of an insight cart of a respective visualization node are organized according to a callout taxonomy (see FIGS. 4A and 4B), mathematical calculations, and sorting mechanisms. They are listed as tables and grouped checkboxes and users can select from either or both. The selected data facts will automatically flow into the insight carts of the successor text nodes.

In some embodiments, an insight cart of a respective text node includes a data facts segment and a visual recommendation segment. The data facts segment pulls aggregate data facts from the text-node's upstream visualization nodes, whereas the visualization recommendation segment uses text-analysis of the user-selected text to generate relevant visualizations, organized by the source datasets. During the vis-to-text generation process, the data facts segment remains accessible, allowing users to select data facts for narrative generation. Similarly, during the text-to-vis generation process, the visual insight segment presents recommended visualizations as potential ‘assets,” allowing users to add them directly to the authoring canvas.

In some embodiments, DataWeaver utilizes React and D3.js on the frontend to create the user interface 110 and interactive visualizations. The backend, built with Python Flask, manages server-side logic and API requests, In some embodiments, the backend utilizes GPT-40 as its LLM along with various computational libraries for text generation, semantic parsing, and advanced computational tasks.

FIG. 1D illustrates a process 150 for bidirectional generation of interactive visualizations and text narratives, in accordance with some embodiments. In FIG. 1D, the solid arrows denote the visualization-to-text generation process flow whereas the dashed lines denote the text-to-visualization process flow.

The visualization-to-text generation process begins at block 151, where a computing device (e.g., computing device 200) receives (152) one or more user interactions with an interactive visualization 154 that is associated with a visualization node 120. For example, in some embodiments, the user interactions include user selection of one or more visual elements (e.g., data marks, a graph, an axis, a title, or a legend) of the interactive visualization that are of interest to the user. The computing device generates (156) (e.g., computes or determines) a list of data facts 158 by applying a callout intent framework 159 that is described with respect to FIGS. 4A and 4B. In accordance with user selection of at least a subset (e.g., one or more) data facts from the list of data facts 158, the computing device sends (159) a request to a language model 160 (e.g., an LLM) that includes the user-selected data facts for narrative generation. The computing device receives (162) from the language model a text narrative 164. The process establishes a visual-text connection 168 between the interactive visualization 154 and the text narrative 164, which further facilitates the creation of visual data stories 170.

The text-to-visualization generation process begins at block 172, where the computing device receives (174) one or more user interactions with a text narrative 164 that corresponds to a text node 130. For example, the user interactions can comprise user selection of one of more portions of the text narrative 164. The computing device takes the selected text and reference data, and sends (176) a request to the language model 160. The computing device receives (178) from the language model 160 relevant analysis and visualizations 179, and receives (180) user selection of one or more of the visualizations. In some embodiments, the computing device generates a visualization specification for rendering charts. The process also establishes a visual-text connection 168 between the interactive visualization 154 and the text narrative 164, which further facilitates the creation of visual data stories 170.

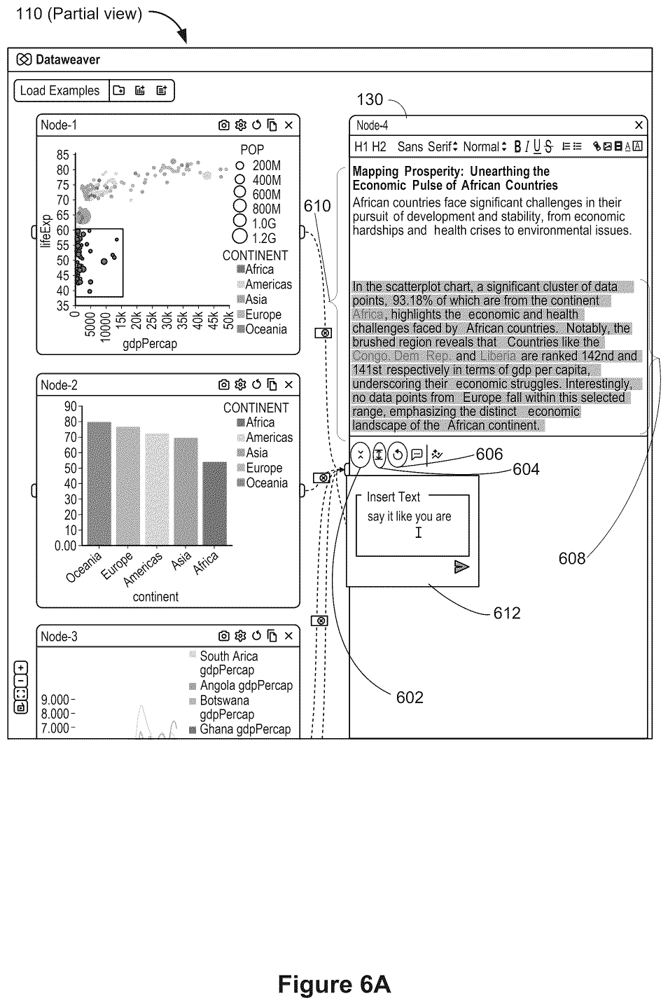

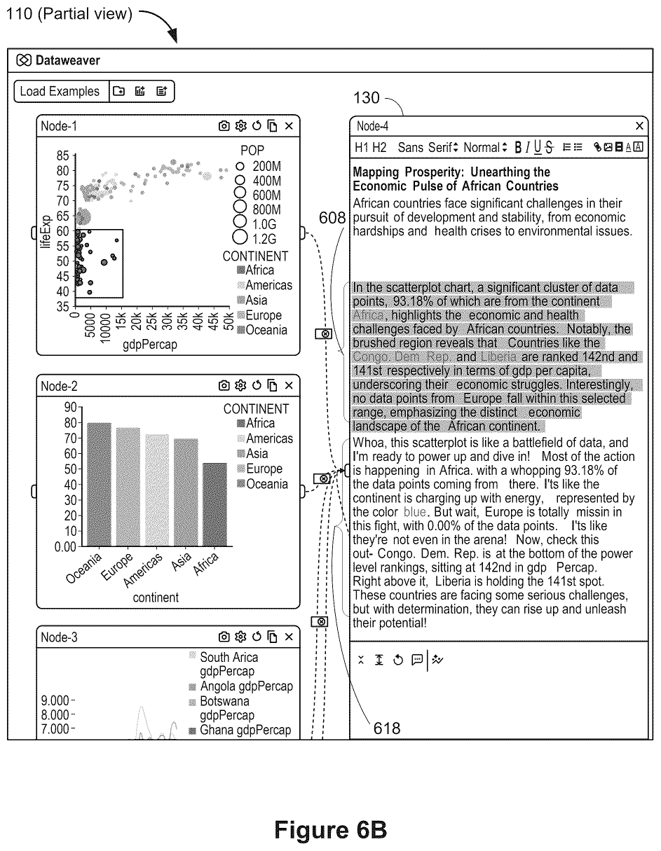

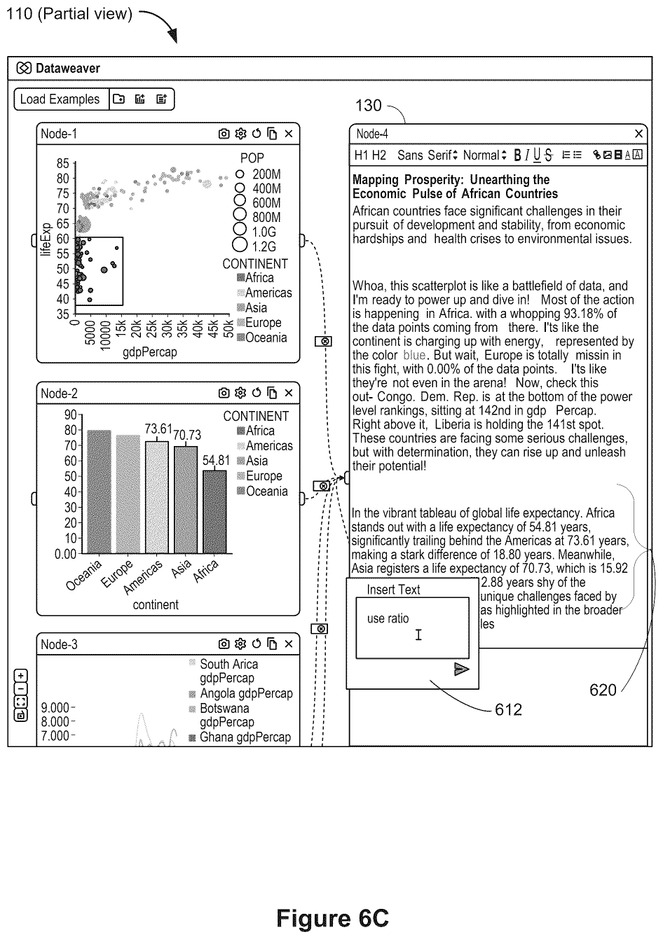

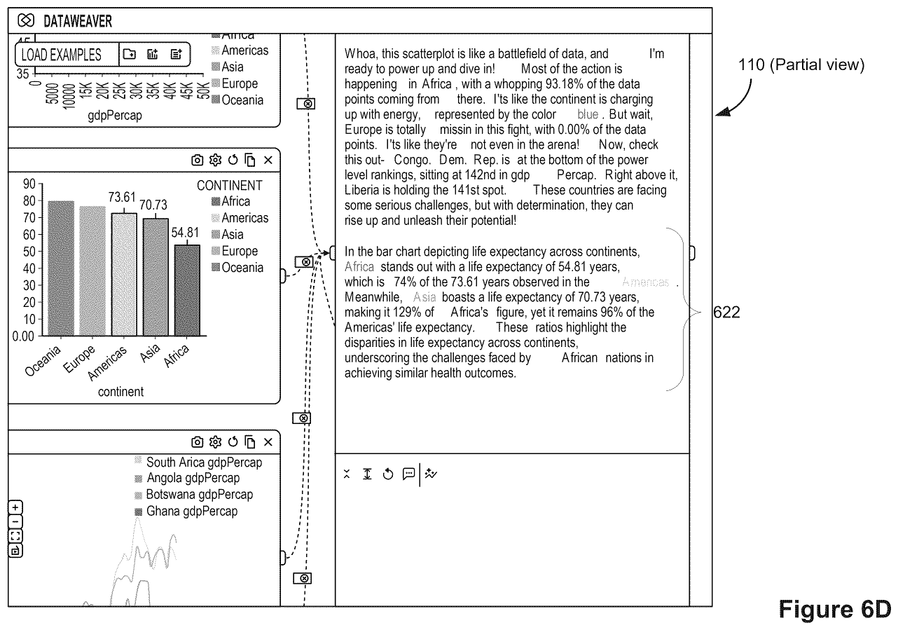

FIG. 1E illustrates a visualization-to-text composition workflow 185, in accordance with some embodiments. In some embodiments, after users apply callout interaction (186) to a visualization (S1), DataWeaver computes the data facts and presents (S2) them in the insight cart. Users can then select (187 and 188) desired data facts (S3). A language model then generates data narratives (S4) based on the selected data facts and metadata. Users can revise the generated narratives using one or more buttons 189 (e.g., affordances 602, 604, and 606), which are discussed with respect to FIG. 6A. Further details of the visualization-to-text composition workflow are also described in the “Visualization-to-Text Composition” section below.

FIG. 1F illustrates a text-to-visualization composition workflow 190, in accordance with some embodiments. Users first type or select text to focus (S-i) and Data Weaver retrieves and processes the datasets from upstream nodes (S-ii). A language model then interprets the text and metadata and recommends relevant charts (S-iii). Based on the charts' types, the language model generates JSON specifications that contain both data operation and visualization schemas used to create interactive charts (S-iv). Users review the generated charts and add desired ones as new visualization nodes (S-v). Further details of the text-to-visualization composition workflow are also described in the “Text-to-Visualization Composition” section below.

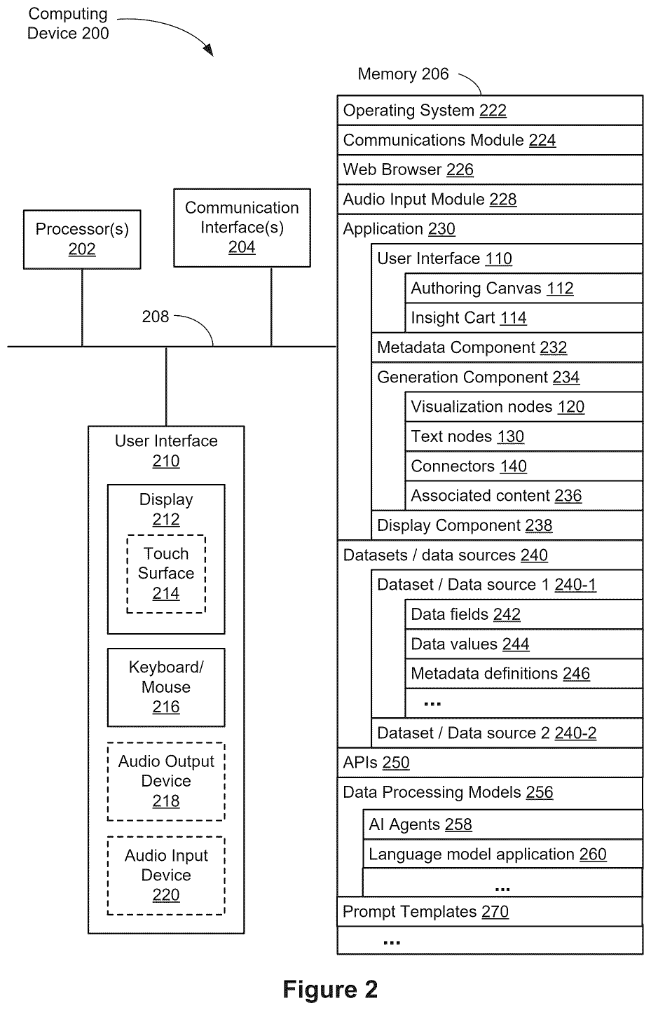

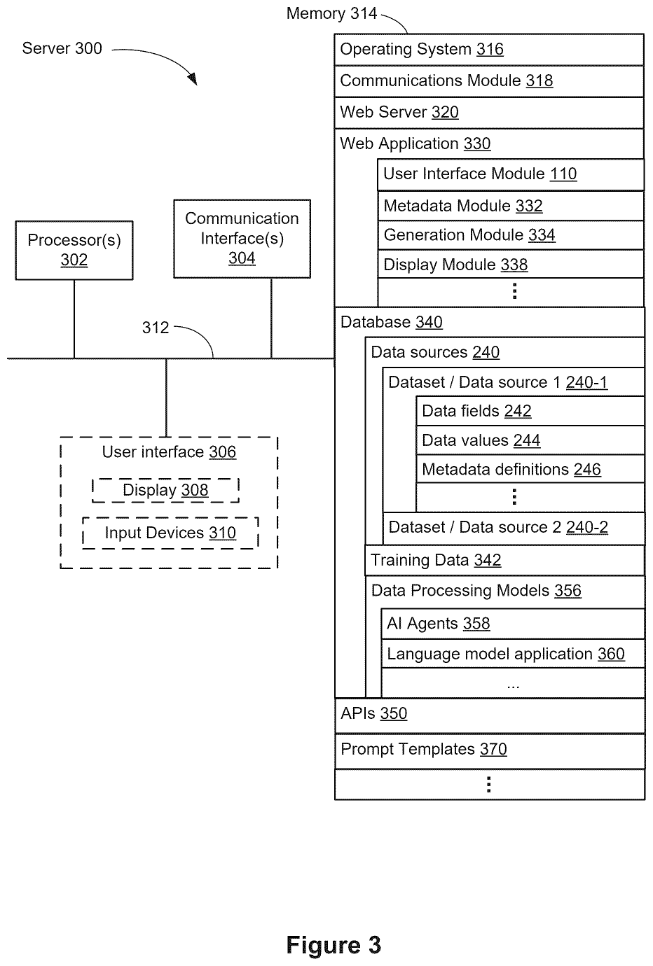

FIG. 2 is a block diagram of a computing device 200, in accordance with some embodiments. Various examples of the computing device 200 include a desktop computer, a laptop computer, a tablet computer, and other computing devices that have a display and a processor capable of running an application 230. In some embodiments, the computing device 200 is a virtual reality (VR) device, an augmented reality (AR) device, or a spatial computing device that blends digital content with the physical world. The computing device 200 typically includes one or more processing units (processors or cores) 202, one or more network or other communication interfaces 204, memory 206, and one or more communication buses 208 for interconnecting these components. In some embodiments, the communication buses 208 include circuitry (sometimes called a chipset) that interconnects and controls communications between system components.

The computing device 200 includes a user interface 210. The user interface 210 typically includes a display device 212. In some embodiments, the computing device 200 includes input devices such as a keyboard, mouse, and/or other input buttons 216. Alternatively or in addition, in some embodiments, the display device 212 includes a touch-sensitive surface 214, in which case the display device 212 is a touch-sensitive display. In some embodiments, the touch-sensitive surface 214 is configured to detect various swipe gestures (e.g., continuous gestures in vertical and/or horizontal directions) and/or other gestures (e.g., single/double tap). In computing devices that have a touch-sensitive display 214, a physical keyboard is optional (e.g., a soft keyboard may be displayed when keyboard entry is needed). The user interface 210 also includes an audio output device 218, such as speakers or an audio output connection connected to speakers, earphones, or headphones. Furthermore, some computing devices 200 use a microphone and voice recognition to supplement or replace the keyboard. In some embodiments, the computing device 200 includes an audio input device 220 (e.g., a microphone) to capture audio (e.g., speech from a user).

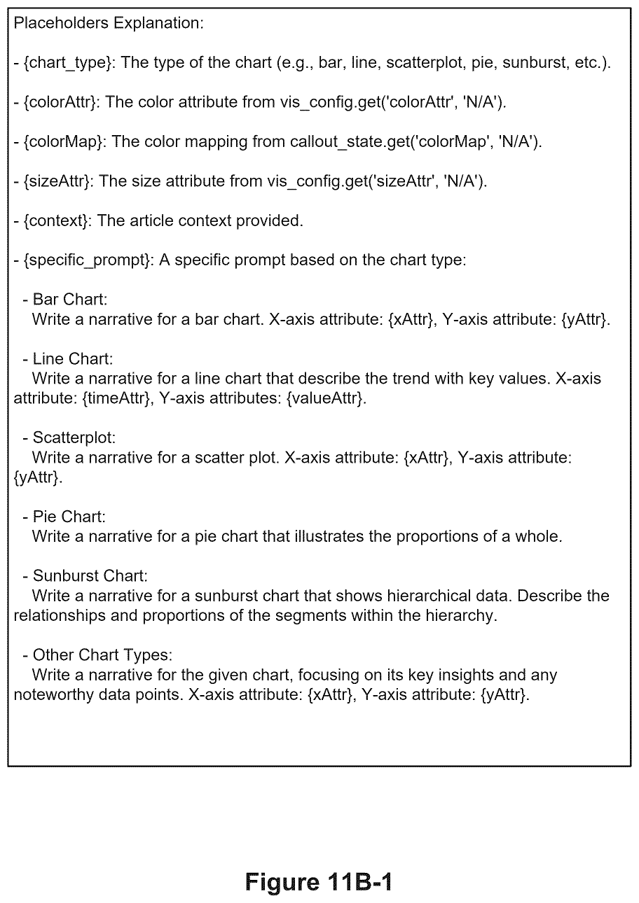

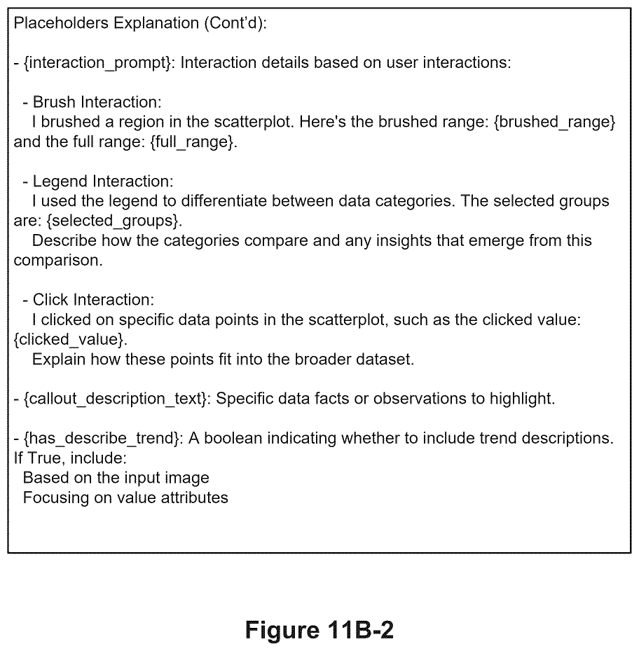

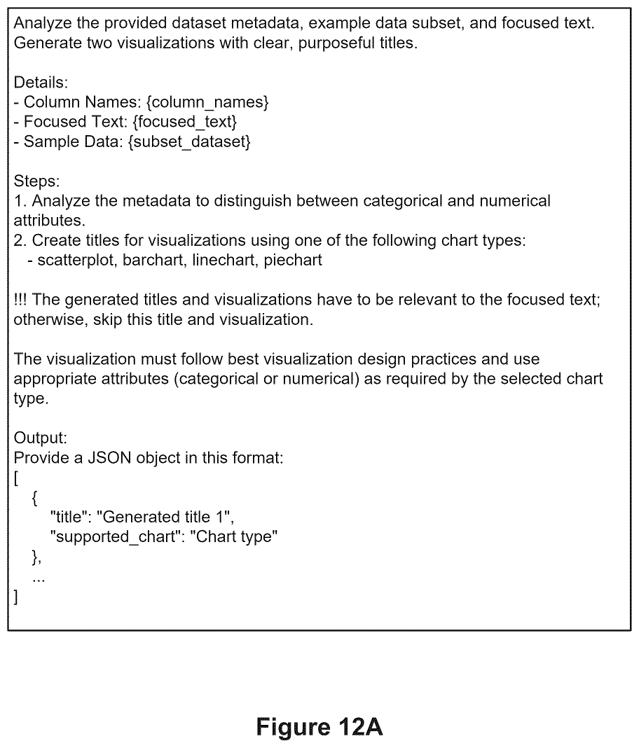

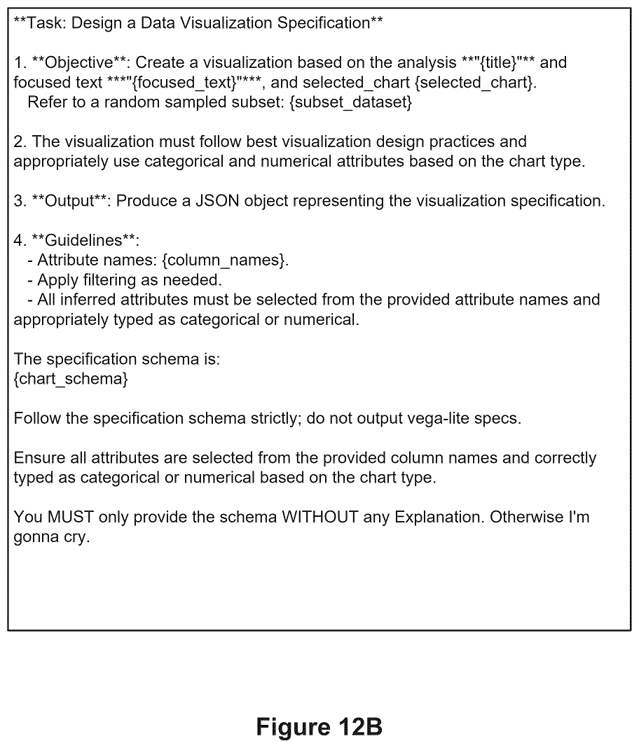

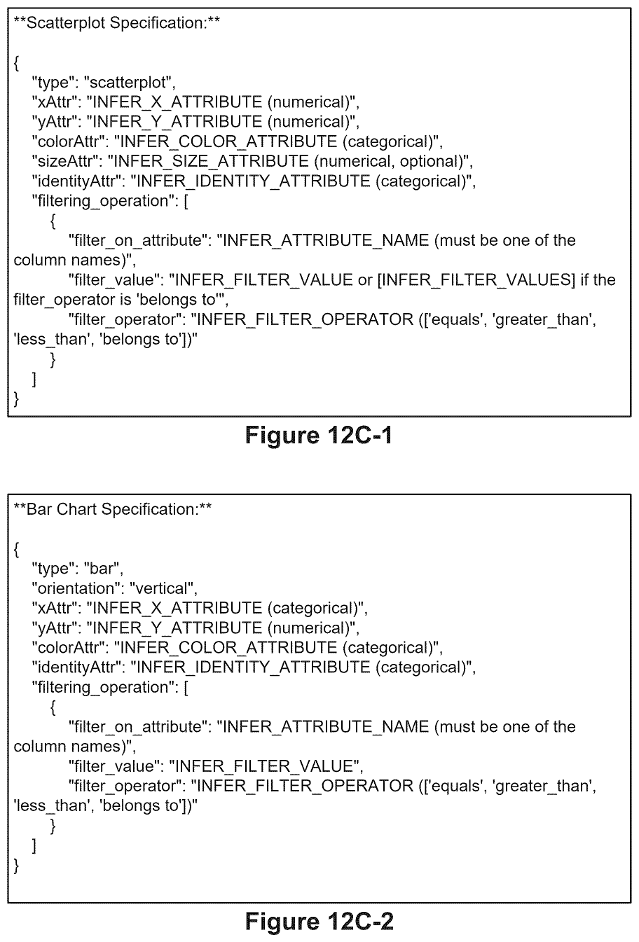

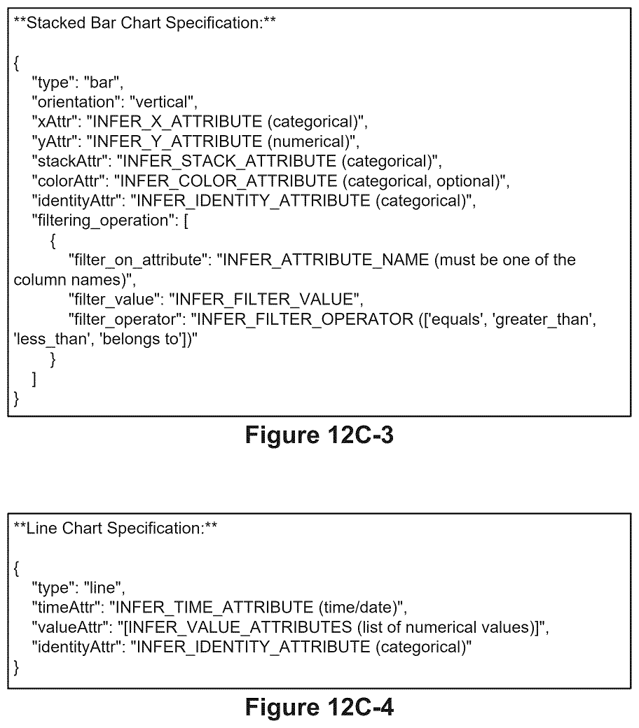

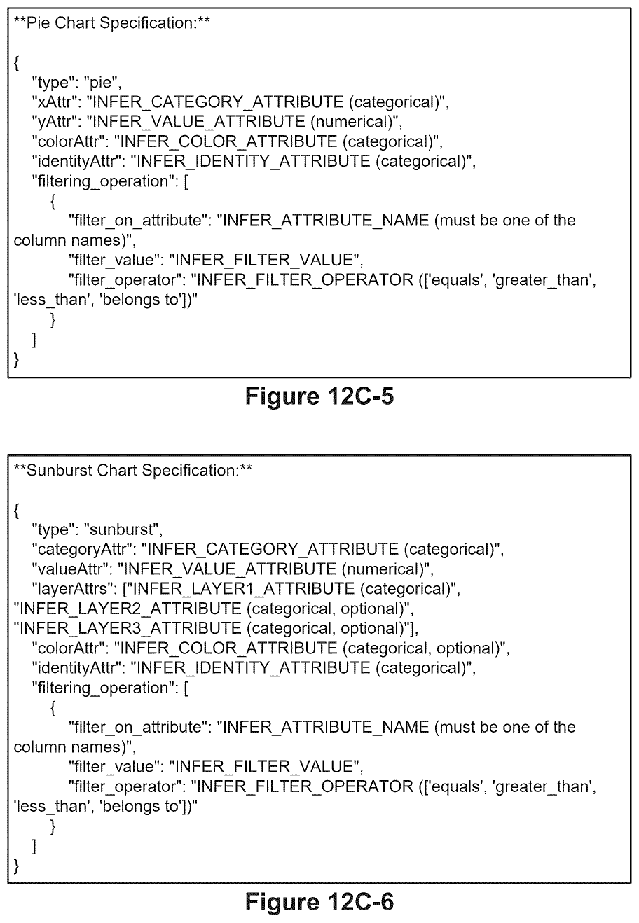

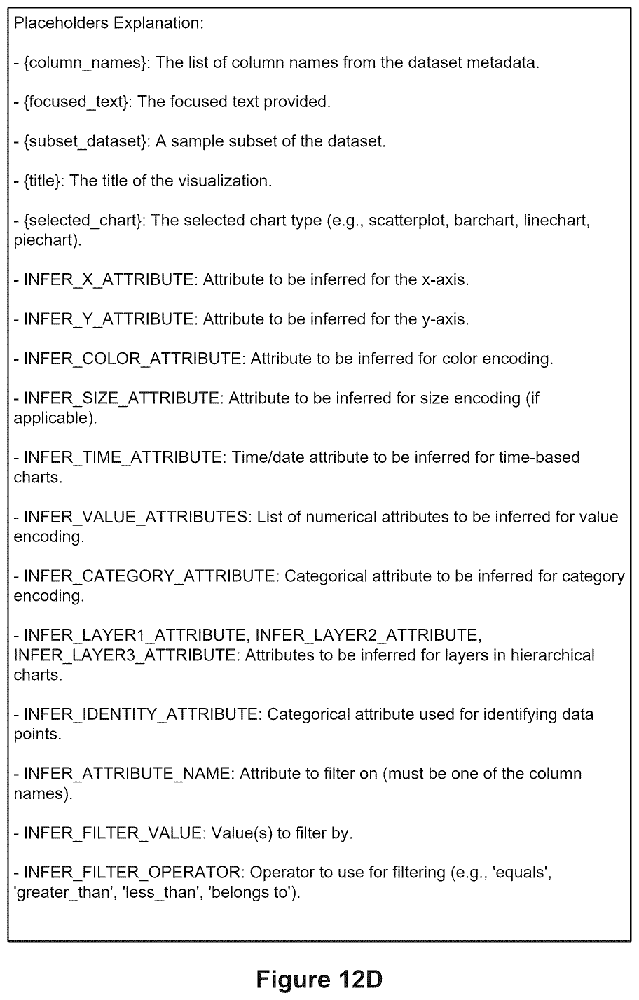

In some embodiments, the memory 206 includes high-speed random-access memory, such as DRAM, SRAM, DDR RAM, or other random-access solid-state memory devices. In some embodiments, the memory 206 includes non-volatile memory, such as one or more magnetic disk storage devices, optical disk storage devices, flash memory devices, or other non-volatile solid-state storage devices. In some embodiments, the memory 206 includes one or more storage devices remotely located from the processors 202. The memory 206, or alternatively the non-volatile memory devices within the memory 206, includes a non-transitory computer-readable storage medium. In some embodiments, the memory 206, or the computer-readable storage medium of the memory 206, stores the following programs, modules, and data structures, or a subset or superset thereof:
an operating system 222, which includes procedures for handling various basic system services and for performing hardware dependent tasks;
a communications module 224, which is used for connecting the computing device 200 to other computers (e.g., server 300) and devices via the one or more communication interfaces 204 (wired or wireless), such as the Internet, other wide area networks, local area networks, metropolitan area networks, and so on;
a web browser 226 (or other application capable of displaying web pages), which enables a user to communicate over a network with remote computers or devices;
an audio input module 228 (e.g., a microphone module), which processes audio captured by the audio input device 220. The captured audio may be sent to a remote server (e.g., a server system 300) and/or processed by an application executing on the computing device 200 (e.g., the application 230 or the language model application 260);
an application 230 (e.g., DataWeaver). In some embodiments, the application 230 utilizes React and D3.js on the front end to create the interface and interactive visualizations. In some embodiments, the backend is built with Python Flask and handles server-side logic and API requests using the OpenAI API and various computational libraries for advanced data processing, text generation, and semantic parsing tasks. In some embodiments, the application 230 includes:
   a user interface 110 (e.g., a graphical user interface, as illustrated in FIGS. 1A to 1C) for displaying visualization nodes 120, text nodes 130, and an insight cart 114, and receiving user interaction with these nodes and the insight cart. In some embodiments, the user interface 110 includes an authoring canvas 112 and an insight cart 114, as illustrated in FIG. 1A;
   a metadata component 232, for generating and/or retrieving metadata;
   a generation component 234, for generating visualization nodes 120, text nodes 130, connectors 140, insight cart 114, and their associated content 236 (e.g., data visualization 122, data narrative 132, callout data facts 406, relevant analysis and visualizations 179);
   a display component 238, for displaying the visualization nodes 120, text nodes 130, connectors 140, and associated content 236 in the user interface 110;
zero or more datasets or data sources 240, which are used by the application 230, and/or the language model application 260. In some embodiments, the datasets/data sources 240 include a first dataset or a first data source (e.g., dataset/data source 1 240-1) and a second dataset or a second data source (e.g., dataset/data source 2 240-2). In some embodiments, a respective dataset or data source 240 can include data fields 242, data values 244 corresponding to the data fields, metadata definitions 246;
APIs 250 for receiving API calls from one or more applications (e.g., a web browser 226, an application 230, and/or language model application 260), translating the API calls into appropriate actions, and performing one or more actions;
data processing models 256 (e.g., AI models) for processing datasets/data sources 240 or callout interactions, and for generating relevant narratives based on the call-out interactions and intent-based data facts. In some embodiments, the data processing models 256 include one or more AI agents 258, and a language model application 260. In some embodiments, the language model application 260 executes one or more large language models such as language model 160 or large language models (LLMs). In some embodiments, language model application 260 executes a generative LLM (e.g., OpenAI© API model gpt-4-turbo-preview); and
prompt templates 270, which are described in FIGS. 11A, 11B, and 12A to 12D.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 206 stores a subset of the modules and data structures identified above. Furthermore, the memory 206 may store additional modules or data structures not described above. In some embodiments, a subset of the programs, modules, and/or data stored in the memory 206 is stored on and/or executed by a server system 300.

Although FIG. 2 shows a computing device 200, FIG. 2 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 200 may be stored or executed on a server system 300.

FIG. 3 is a block diagram of a server system 300, in accordance with some embodiments. The server system 300 typically includes one or more processing units/cores (CPUs) 302, one or more network interfaces 304, memory 314, and one or more communication buses 312 for interconnecting these components. In some embodiments, the server system 300 includes a user interface 306, which includes a display 308 and one or more input devices 310, such as a keyboard and a mouse. In some embodiments, the communication buses 312 include circuitry (sometimes called a chipset) that interconnects and controls communications between system components.

In some embodiments, the memory 314 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. In some embodiments, the memory 314 includes one or more storage devices remotely located from the processors (e.g., CPU(s)) 302. The memory 314, or alternatively the non-volatile memory devices within the memory 314, comprises a non-transitory computer readable storage medium.

In some embodiments, the memory 314 or the computer readable storage medium of the memory 314 stores the following programs, modules, and data structures, or a subset thereof:
an operating system 316, which includes procedures for handling various basic system services and for performing hardware dependent tasks;
a network communications module 318, which is used for connecting the server 300 to other computers via the one or more communication network interfaces 304 (wired or wireless) and one or more communication networks, such as the Internet, other wide area networks, local area networks, metropolitan area networks, and so on;
a web server 320 (such as an HTTP server), which receives web requests from users and responds by providing responsive web pages or other resources;
a web application 330 (e.g., DASH web application), which may be downloaded and executed by a web browser 226 on a user's computing device 200. In general, a web application 330 has the same functionality as a desktop application 230, but provides the flexibility of access from any device at any location with network connectivity, and does not require installation and maintenance. In some embodiments, the web application 330 includes various software modules to perform certain tasks, such as:
   a user interface module 110, which provides the user interface for all aspects of the web application 330;
   a metadata module 332, which has the same functionalities as metadata component 232;
   a generation module 334, which has the same functionalities as generation component 234; and
   a display module 338, which has the same functionalities as display component 238.

In some embodiments, the server system 300 includes a database 340. In some embodiments, the database 340 includes zero or more datasets or data sources 240, which are used by the web application 330 and/or the language model web application 360. In some embodiments, the datasets/data sources 240 include a first dataset or a first data source (e.g., Dataset/Data source 1 240-1), and a second dataset or a second data source (e.g., Dataset/Data source 2 240-2) In some embodiments, a respective dataset or data source 240 includes data fields 242, data values 244 corresponding to the data fields, and metadata definitions 246.

In some embodiments, the database 340 includes data processing models 356 (e.g., AI models) for processing datasets/data sources 240 or callout interactions, and for generating relevant narratives based on the call-out interactions and intent-based data facts. In some embodiments, the data processing models 356 include one or more AI agents 358, and a language model application 360. In some embodiments, the language model application 360 executes one or more large language models such as language model 160 or large language models (LLMs). In some embodiments, language model application 260 executes a generative LLM (e.g., OpenAI© API model gpt-4-turbo-preview) In some embodiments, the data processing models 356 are trained via training data 342.

In some embodiments, the memory 314 stores APIs 350 for receiving API calls from one or more applications (e.g., a web server 320, a web application 330, and/or a language model web application 360), translating the API calls into appropriate actions, and performing one or more actions.

In some embodiments, the memory 314 stores prompt templates 370, which are described in FIGS. 11A, 11B, and 12A to 12D.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 314 stores a subset of the modules and data structures identified above. Furthermore, the memory 314 may store additional modules or data structures not described above.

Although FIG. 3 shows a server system 300, FIG. 3 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 300 may be stored or executed on a computing device 200. In some embodiments, the functionality and/or data may be allocated between a computing device 200 and one or more servers 300. Furthermore, one of skill in the art recognizes that FIG. 3 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

FIGS. 4A and 4B illustrate a callout intent framework 159, in accordance with some embodiments. This callout intent framework 159 in FIGS. 4A and 4B is intended to be illustrative and expandable with additional chart types and interactions. The callout intent framework 159 includes a list of exemplary chart types 402, including standard charts such as scatterplots, bar charts, line charts, and donut charts, and advanced charts such as stacked bar charts and sunburst charts. Each chart type includes corresponding callout interactions 404 (e.g., user interactions with a chart).

As disclosed, DataWeaver captures interaction data and metadata when a user interacts with a portion of a chart that is displayed in a visualization node, or a portion of a text that is displayed in a text node. In some embodiments, the metadata is categorized into three categories: data metadata, chart metadata, and interaction metadata.

In some embodiments, data metadata contains all the attribute names (e.g., field names of data fields) of the underlying datasets along with their corresponding value types (e.g., whether the data fields are dimension or categorical fields, numerical or measure fields, or temporal fields such as date/time fields).

In some embodiments, chart metadata includes all visual encodings, such as the x- and y-axes, color, and size, which vary depending on the chart type. This metadata also defines the content of tooltips. In some embodiments, Data Weaver by default places variables that are visually mapped (e.g., x- and y-values for a scatterplot) and identity variables (e.g., a country's name or a movie's title) in the tooltips, although users have the option to customize these settings.

In some embodiments, interaction metadata varies according to the chart and interaction types. For instance, in a brushing interaction, Data Weaver captures the 2D range [x1, y1] to [x2, y2] for a scatterplot, or the 1D range [x1, x2] or [y1, y2] for a bar chart. For a line graph, it records the start and end dates/times. Additionally, it captures the specific data points or ranges that users select for discrete selections.

In some embodiments, upon receiving the callout data, DataWeaver's backend generates (e.g., computes) callout data facts 406 and transforms them into template-based data facts, which are presented in the insight cart for a visualization node.

FIG. 4C illustrates example data facts generated by Data Weaver in response to detecting a user interaction comprising brushing over a region of a scatterplot, in accordance with some embodiments. In some embodiments, the data facts are organized hierarchically in a nested structure to enhance clarity and ease of interpretation. In some embodiments, the data facts are sorted by categories based on the taxonomy illustrated in FIGS. 4A and 4B and for UI consistency. For example, Mode data facts are on top of Rank data facts for brushing a scatterplot. The statistical table always appears at the top for UI consistency.

### Bidirectional Content Generation

Besides the fundamental features for authoring interactive visualizations and creating nodes and edges, DataWeaver's core functionality lies in its support for bidirectional content composition.

In accordance with some embodiments, DataWeaver is configured to perform a visualization-to-text content generation process and a text-to-visualization content generation process. Each of these processes can be repeated as needed. A visualization-to-text content generation process can be combined with a text-to-visualization content generation process, and vice versa.

### Visualization-to-Text Composition

In some embodiments, the visualization-to-text composition follows an interact-compute-select-generate-revise workflow where users (e.g., authors), computing algorithms (e.g., computing device 200, application 230 or web application 330 executing DataWeaver) and a language model (e.g., language model application 260, language model web application 360, LLMs, Generative Pre-trained Transformers (GPTs) each handles respective steps, denoted by steps S1 to S5 below.

Step S1. A user interacts with charts to highlight visual elements. In each visualization node, users initiate callout interactions to select the visual elements of interest, after which the system retrieves and dispatches a package containing the selected data subset, along with its metadata and interaction details. In some embodiments, the metadata is divided into three categories: (i) data metadata, which includes attribute names and value types (categorical, numerical, or temporal); (ii) chart metadata, which captures visual encodings like axes, color, size, and tooltip content (e.g., mapped variables such as x/y values or identity variables like a country's name); and (iii) interaction metadata, which varies depending on the chart and interaction type. For instance, brushing a scatterplot captures a 2D spatial selection with coordinate ranges [x1, y1] to [x2, y2] and value ranges [xValue1, yValue1] to [xValue2, yValue2].

Step S2. Data Weaver algorithms compute and organize data facts. In some embodiments, upon receiving the “callout package,” Data Weaver's backend computes the relevant statistics following the taxonomy (e.g., FIGS. 4A and 4B) and converts them into a statistical table or template-based data facts, such as “95.24% of the selected data points (40 occurrences) have the attribute “continent=Africa”, “Swaziland is ranked 142nd out of 142 in lifeExp, or “Gabon is an outlier in lifeExp.” These data facts are presented in the Vis-nodes' insight cart. To manage this potentially extensive list of data facts and reduce users' cognitive load, in some embodiments, DataWeaver categorizes them based on derived callout intents and applies sorting mechanisms to the list. The data facts are organized hierarchically in a nested structure: Fact Types>Attributes>Data Facts. This ordering balances data-fact relevance with computational efficiency by surfacing the most relevant fact types while culling entire variables from the fact generation calculations. The following two examples illustrate.

Mode Example. As used herein, in some embodiments, the term “mode” refers to respective counts (or respective relative counts, expressed as a ratio or a percentage) of data values of a data field or respective frequencies of occurrences (or respective relative frequencies of occurrences) of data values of a data field. In some embodiments, DataWeaver ranks modes by calculating their weighted scores, considering normalized differences, normalized ratios, and normalized entropy. In some embodiments, the mode's score Wᵢ is computed as:

$${W}_{i} = {D}_{i}^{norm} + a \times {R}_{i}^{norm} + b \times ( \frac{{count}_{i}}{{total}_{{count}_{S}}} ) - {E}_{i}^{norm}$$

Modes are then sorted in descending order based on the score, prioritizing significant deviations and prominence within the subset. For instance, when brushing over the lower quadrant in a scatterplot that visualizes life expectancy vs. GDP per capita, this algorithm promotes data facts that represent “most countries selected are African countries” and “none of them are European countries.”

Rank Example: In some embodiments, DataWeaver elevates extreme ranks (or values) by alternating between the highest and lowest values, highlighting significant data points from both ends of the spectrum (e.g., first, last, second, second to last, and so on). For instance,
“1. Oceania is ranked 1st out of 5 in lifeExp.
2. Africa is ranked 5th out of 5 in lifeExp.
3. Europe is ranked 2nd out of 5 in lifeExp.
4. Asia is ranked 4th out of 5 in lifeExp.
5. Americas is ranked 3rd out of 5 in lifeExp”

Outlier Sorting: Outliers are ranked using the Z-Score, which measures how many standard deviations a data point is from the mean. The Z-Score is calculated as:

$$Z = \frac{X - μ}{σ}$$

where X is the data point, μ is the mean of the dataset, and σ is the standard deviation. The greater the absolute Z-Score, the more extreme the outlier. DataWeaver sorts outliers by these scores, with the most significant outliers appearing at the top.

Difference Sorting: Differences between data points are sorted by the magnitude of the difference, with the largest differences ranked at the top. This ensures that the most significant differences are highlighted first. For instance, when comparing GDP per capita between countries, the largest gap between any two selected data points would be ranked highest in the list. For example:
1. Oceania (80.72)'s lifeExp is 25.91 higher than Africa (54.81).
2. Europe (77.65)'s lifeExp is 22.84 higher than Africa (54.81).
3. Americas (73.61)'s lifeExp is 18.80 higher than Africa (54.81).
4. Asia (70.73)'s lifeExp is 15.92 higher than Africa (54.81).

In some embodiments, in addition to computed statistical data facts, Data Weaver also retrieves an image of the annotated visualization (e.g. a .tif image, a .jpg image or .png image, or a .pdf file) and provides an option to describe the appearance of the visualization.

In some embodiments, the Fact Type layer ordering is guided by both the taxonomy (see, e.g., FIGS. 4A and 4B) and the goal of maintaining UI consistency. For example, in some embodiments and as illustrated in FIG. 4C, the statistical table is always placed at the top to ensure uniformity across the interface, and the Frequency category (e.g., Mode Data Facts) is positioned above the Rank category (e.g., Rank Data Facts) when brushing a scatterplot.

In some embodiments, the Attribute layer does not adhere to a specific ordering scheme. However, to reduce the computational load from handling numerous attributes and ease users' cognitive load when reviewing data facts, DataWeaver processes only the attributes of interest, i.e., variables that are visually mapped and explicitly selected by the user for display in tooltips.

In some embodiments, within each list, Data Facts are sorted based on their “significance” or “interestingness.” In some embodiments, DataWeaver uses different sorting algorithms tailored to specific fact types, aiming to highlight the most “significant” data facts within each category. For example, when brushing over the lower quadrant of a scatterplot visualizing life expectancy against GDP per capita, DataWeaver surfaces data facts like “most countries selected are African countries” but “none of them are European countries” in the Frequency×Continent category. Data Weaver sorts these frequency data facts by calculating weighted scores, taking into account normalized differences, ratios, and entropy, while prioritizing significant deviations and prominence within the subset. A detailed sorting mechanism is present in FIG. 4D.

Step S3. The user selects the data facts. In some embodiments, a user can click on the statistical table cells or checkboxes to select individual or grouped data facts they would like included from each visualization node. The selected data facts are then streamed to the subsequent text nodes, where they appear in the corresponding insight cart in a nested format.

Step S4. The language model generates data narratives. In some embodiments, the narrative generation can be triggered by the user pressing a key (e.g., Tab key or carriage return key) or by selecting an icon on the user interface 110. The selected data facts are then fed to the language model, along with the preceding context and metadata, organized into a prompt template. The prompt template encapsulates both a generic template and chart-specific templates, as illustrated in FIGS. 11A and 11B.

FIG. 11A illustrates a visualization-to-text prompt template (e.g., generic template), in accordance with some embodiments. In some embodiments, the visualization-to-text prompt template specifies steps and placeholders to guide the writing process. The generic template offers a structured approach to understanding the visualization and its context. It includes steps such as recognizing the visualization type, examining the article context, and synthesizing data facts into a coherent narrative.

FIGS. 11B-1 and 11B-2 illustrate a visualization-to-text prompt template for chart-specific prompts (e.g., type-specific templates), in accordance with some embodiments. The template describes each placeholder used in the prompt template and provides details on what data should replace each placeholder. The type-specific templates, as illustrated in FIGS. 11B-1 and 11B-2, provide tailored guidance and context. For example, brushing interactions provide the range of the brushed area versus the full axes range. A pseudo example prompt is as follows:
(1) Understand the visualization: chart type, chart metadata
(2) Consider the context: “preceding text content”
(3) Consider the callout interaction: interaction metadata
(4) Focus on these data facts: [“data fact 1” . . . ].
(5) Synthesize information and write a narrative based on the data facts.

In some embodiments, for requests to describe the appearance of an annotated chart, the retrieved image is incorporated into the prompt as visual input to leverage the language model's chart reading capability. In some embodiments, to minimize potential errors, DataWeaver uses this feature in accordance with (e.g., only upon) users' requests and incorporates accurate key data points (e.g., peaks, valleys, or start/end points in a brushed timeframe) to enhance accuracy.

The generated narrative will appear at the bottom of the focused text node, allowing users to accept/reject it into the main text.

Step S5. The user and the language model revise the generated data narrative. After accepting the initial narrative, the user can either manually revise it or use the language model for further refinement. For example, the user can select any part of the generated content and prompt the language model to revise it. In some embodiments, Data Weaver offers three shortcut buttons (e.g., shorten, expand, regenerate, see affordances 602, 604, and 606) and a text instruction window. The pre-defined or user-specified instructions will be integrated into a new prompt alongside the generated content and the original prompt to ensure that the new content accurately aligns with the data facts.

FIGS. 5A to 5G are screenshots illustrating the generation of text narratives from visualization nodes, in accordance with some embodiments.

FIG. 5A illustrates display of visualization nodes 120-2, 120-3, 120-4, and 120-5, and text node 130-2 in the user interface 110. The visualization node 120-2 is connected to the text node 130-2 via connector 140-2 and includes a scatter plot 502 (e.g., data visualization or chart). The visualization node 120-3 is connected to the text node 130-2 via connector 140-3 and includes a bar chart 504. The visualization node 120-4 is connected to the text node 130-2 via connector 140-4 and includes a bar chart 506. The visualization node 120-5 is connected to the text node 130-2 via connector 140-5 and includes a series of line graphs 508. In FIG. 5A, each of the visualization nodes 120-2, 120-3, 120-4, and 120-5 is upstream of the text node 130-2, meaning that data flows from the upstream visualization nodes to the downstream text node 130-2.

FIG. 5B shows a closer-up view of the user interface 110. In this example, the scatter plot 502 is a graph of life expectancy versus GDP per capita across different continents. The size of the data marks (e.g., circles) in the scatter plot 502 indicates the population size. Different colors are used to visually represent different data values of the data field “continent.” For example, data marks belonging to the continent “Africa” are encoded with the color blue, data marks belonging to the continent “Americas” are encoded with the color yellow, data marks belonging to the continent “Asia” are encoded with the color red, data marks belonging to the continent “Europe” are encoded with the color turquoise, and data marks belonging to the continent “Oceania” are encoded with the color green. The text node 130-2 includes an initial text narrative 510 and a title 512 describing economy of countries in the African continent.

According to some embodiments of the present disclosure, Data Weaver supports the generation of data narratives by using authors' callout interactions and computing data facts based the interactions, according to the callout intent framework 159 that is illustrated in Figured 4A and 4B. FIG. 5C illustrates a user interaction with the scatter plot 502. In this example, the user (e.g., via a mouse) brushes over a region 514 of the chart that reflects lower life expectancy per capita. In some embodiments, in response to the user interaction, DataWeaver automatically determines a set of data facts according to the callout intent framework 159, and displays the data facts as selectable options (e.g., selectable options 515-1, 515-2, and 515-3) in the insight cart 114. This is illustrated in FIG. 5C. In some embodiments, the set of data facts that are computed correspond to data facts 410 in FIG. 4A (e.g., based on a determination by Data Weaver that the chart type in this case is a scatterplot and the callout interaction is an area interaction (i.e., a 2-D brush)).

As described above, DataWeaver captures interaction data and metadata when a user interacts with a portion of a chart. The metadata includes data metadata, chart metadata, and value metadata. In the example of FIG. 5C, when a user brushes over the region 514 of the scatterplot the metadata is structured as follows:
Data metadata:
   Attribute Names (field names): [lifeExp (numerical), gdpPercap (numerical), country (categorical), continent (categorical), population (numerical), etc.]
Chart Metadata:
   Visual Mapping:
      x-attributes (xAttr): gdpPercap
      x-attributes (yAttr): lifeExp
      color attributes (colorAttr): continent
      size attributes (sizeAttr): pop
      identity attributes (identityAttr): country
      tooltip attributes (tooltipAttr): [gdpPercap, lifeExp, continent, pop, country]
Interaction metadata:
   Brushed Scale: [x1y1] [x2y2] (coordinates)
   Brushed Range: [xValue1yValue1] [xValue2yValue2] (actual values)
   Computed Statistics/Values:
      Descriptive Stats: Average, max, median, min, range, and standard deviation for each numerical attribute in the focused selection, e.g., avg gdpPercap/lifeExp/pop.
      Mode Data Facts: For categorical attributes, e.g., 87.23% of selected data points represent African countries.
      Rank: For each numerical attribute, the rank of each selected data point within the selected data and among all data points. For example, Liberia is ranked 141st out of 142 in gdpPercap globally and 46th out of 47 within the selected data points.
      Outlier Detection: Indicates whether the selected data point is an outlier both locally and globally.
      Group vs. Global Statistics: Provides a comparison of the selected data points against the global dataset statistics.

FIG. 5D illustrates a user interaction with data bars 516 (e.g., data bars 516-1 to 516-5) of the bar chart 504 in the visualization node 120-3, in accordance with some embodiments. In this example, the bar chart 504 shows life expectancies across different continents. The user selects the data bars 516-1 to 516-5 (e.g., by individually or discretely clicking on each of the data bars). In response to the user selection, Data Weaver generates (e.g., determines) a set of data facts (e.g., data facts 410 in FIG. 4A) and displays them in the insight cart 114, the user selects the rank data facts with the intention of enumerating the values.

FIG. 5E shows another user interaction, this time with the bar chart 506 in visualization node 120-4. The bar chart 506 shows a graph of life expectancy across countries in the African continent, in this example, the user would like to highlight countries in Africa with low life expectancy. The user brushes over a few data bars 520. The user action causes Data Weaver to generate a set of data facts (e.g., data facts 410) and display the set of data facts in the insight cart 114. The user selects (522) the data facts, selects (524) data fields (e.g., attributes) “continent”, “country”, “GDP per capita”, and “life expectancy of population.” As will be described later, these data fields will be subsequently input into a language model that is configured to generate a narrative based on these data fields.

FIG. 5F illustrates a set of data facts that are generated by Data Weaver and displayed in the insight cart 114, in response to a user brush-over interaction with the line graphs 508 of the visualization node 120-5, in accordance the user brushes over segments of the line graphs and selects (526) data facts, as the user intends to have a narrative to discuss economic growth in some of the African countries.

In some embodiments, the user-selected data facts based on user interactions with the charts in the visualization nodes 120-2, 120-3, 1204-4, and 120-5 as described above will contribute to the insight cart for a downstream node. In the example of FIGS. 5A to 5G, the downstream node is the text node 130-2. FIG. 5G shows that the data facts in the insight cart 114 are grouped according to source node. In some embodiments, the user can select a group of data facts corresponding to a respective source node, press a key (e.g., tab key or enter key) or select an icon on the user interface 100, to generate a paragraph of data narrative for the respective source node. In some embodiments, one paragraph of text is generated for a respective source node. FIG. 5G shows that the data narratives are added to the initial as additional paragraphs 528 and 530. In FIG. 5G, the references to different data values of the data field Continent (i.e., the data values Africa, Americas, Asia, Oceania, and Europe) have the same color encoding as the corresponding charts 502 and 504.

FIGS. 6A to 6D illustrate affordances (e.g., user-selectable icons, buttons, or shortcut icons) of a text node 130, for modifying a generated data narrative, in accordance with some embodiments.

FIG. 6A illustrates that in some embodiments, the text node 130 includes an affordance 602 that, when selected by a user, shortens (e.g., reduces a length of) a selected portion 608 of a text narrative 610 according to the same set of data facts that are used to generate the initial text narrative 610. In some embodiments, the text node 130 includes an affordance 604 that, when selected by a user, expands (e.g., increases a length of) a selected portion 608 (e.g., one or more paragraphs) of a text narrative 610 according to the same set of data facts that are used to generate the initial text narrative 610. In some embodiments, the text node 130 includes an affordance 606 that, when selected by a user, expands (e.g., increases a length of) a selected portion 608 of a text narrative 610 according to the same set of data facts that are used to generate the initial text narrative 610.

In some embodiments, each of the affordances 602, 604, and 606 is pre-configured with a respective set of instructions. User selection of a respective affordance causes the respective corresponding set of instructions to be integrated into a new prompt, alongside the generated content and the original prompt, to ensure that the new content accurately aligns with the data facts.

In some embodiments, the text node 130 includes an input box 612 that enables a user to specify a narrative tone of the text narrative. For example, in FIG. 6A, a user selects the portion 608 of the text narrative and specifies, via the input box 612, to express the portion of the text narrative as though the author is Goku (e.g., “say it like you are Goku”). FIG. 6B shows that in response to the user specification, DataWeaver (via the language model application 260 or 360) displays a new paragraph 618 that has the same data facts as the portion 608, expressed in the narrative tone of the fictional character of Goku.

In FIG. 6C, the user selects paragraph 620 and specifies, in the input box 612, a request to “use ratio” to express the selected paragraph. FIG. 6D shows that in response to the user request, the user interface displays a regenerated paragraph 622 of the original paragraph 620, which is regenerated from the selected paragraph, in which comparisons between life expectancies in different continents are expressed in percentages (e.g., ratios) instead of absolute numbers.

### Text-to-Visualization Composition

As disclosed, in some embodiments, DataWeaver utilizes the strength of language models to understand and infer contextually relevant information, enabling authors to expand their narratives using relevant information from the data. Data Weaver also leverages the language model's capability in semantic parsing and provide a well-structured JSON specification that can be used for data operations and visualization generation.

In some embodiments, the text-to-visualization composition process follows an interact-compute-select-generate-revise workflow where users (e.g., authors), computing algorithms (e.g., computing device 200, application 230 or web application 330 executing DataWeaver) and a language model (e.g., language model application 260, language model web application 360, LLMs, Generative Pre-trained Transformers (GPTs) each handles respective steps, denoted by steps S-i to S-v below (and also illustrated in FIG. 1F).

Step S-i. User selects or enters (e.g., types) text to focus. In some embodiments, using a text editor, a user can select any portion of the existing text they intend to focus on or type new sentences. For example, an author may focus on a specific region of Africa and type “Countries in North Africa . . . ”, select this segment, and click the “Recommend Visualization” button.

Step S-ii. Data Weaver retrieves and processes the datasets. In some embodiments, Data Weaver simultaneously retrieves all the underlying datasets from upstream nodes as reference data and dispatches them for further processing, including extracting attribute names and randomly sampling the datasets. In some embodiments, this process aims to provide an overview of the available datasets without uploading the entire dataset.

Step S-iii. The language model interprets the narrative and recommends relevant analyses and supporting visualizations. In some embodiments, the selected text from Step S-i, attribute names, and a random subset of each underlying dataset (collected from Step S-ii) are fed into the language model. The prompt (see, e.g., FIGS. 12A and 12B) from Data Weaver to the language model instructs the language model to first understand the available datasets using the processed information from Step S-ii and then recommend relevant analyses and visualizations for the selected text. For instance, providing the narrative “Women's participation in the Olympics has increased over time” along with a reference dataset that includes athletes' counts by gender throughout Olympic history prompts the language model to generate suggestions for analyses and visualizations, such as the percentage or count of genders over the years and a line chart to support that analysis.

Step S-iv. The language model generates JSON specifications for data operation and visualization generation. In some embodiments, based on different chart types, Data Weaver prompts the language model to generate a JSON specification for the data operations (e.g., filtering, aggregation) and visualization creation. This is illustrated in FIGS. 12A, 12B, and 12C.

FIG. 12A illustrates a text-to-visualization prompt template that is generated by Data Weaver, in accordance with some embodiments. The text-to-visualization prompt template is for generating visualizations relevant to a focused text based on dataset metadata and a data subset, and guides the creation of two meaningful visualization titles that align with the provided focused text.

FIG. 12B illustrates a text-to-visualization prompt template, in accordance with some embodiments. The text-to-visualization prompt template is for generating a data visualization specification based on a selected chart type, title, dataset subset, metadata, and focused text, and outlines the steps and guidelines for creating a visualization specification.

FIGS. 12C-1 to 12C-6 illustrate templates for various chart specifications, in accordance with some embodiments. These figures include templates for various chart specifications and detail the structure and required attributes for chart types, including a scatterplot, a bar chart, a stacked bar chart, a line chart, a pie chart, and a sunburst chart.

FIG. 12D explains each placeholder used in the prompt templates and chart specifications, in accordance with some embodiments.

with continued reference to Step S-iv, in some embodiments as used herein, “data operation” refers to the output of the language model. For example, if the upstream node passes down a dataset that includes each country's GDP, and the language model infers from the text that a user would like a visualization of a bar chart with the average GDP for each continent, it will generate a data operation that aggregates the values, e.g., groupBy=“continent,” calculation=“average”. Then, the language model uses the new value to create the bar chart. Under the hood, Data Weaver uses a JSON schema tailored for D3 to render different visualizations. For example, a scatterplot requires numerical xAttr and yAttr as mandatory inputs, while other attributes (e.g., colorAttr) are optional. The language model leverages these schemas to generate corresponding JSON specifications, allowing Data Weaver to create visualizations with integrated callout interactions, which are then displayed in the visual insight section of the text node's insight cart.

Step S-v. User selects generated visualizations. Eventually, users review the recommended charts and, by clicking an “add” button, select those they wish to incorporate into the authoring canvas as new visualization nodes. These new nodes are now available for interaction, data-fact generation, and narrative inclusion in the same manner as the existing visualization nodes. The new visualization nodes have now completed the bidirectional loop, allowing users to generate new data facts and narratives that are relevant to the focused text.

FIGS. 7A to 7C are screenshots illustrating the generation of visualization content from text nodes, in accordance with some embodiments.

FIG. 7A shows the user interface 110 includes visualization nodes 120-6, 120-7, and 120-8 that are each connected to text node 130-3 via connectors 140-6, 140-7, and 140-8, respectively. The visualization node 120-6 includes a chart 702 (e.g., a data visualization); The visualization node 120-7 includes a chart 704; and the visualization node 120-8 includes a chart 706. A user selects (e.g., highlights) a portion 708 of the text that is displayed in the text node 130-3. In the example of FIG. 7A, because the visualization nodes 120-6, 120-7, and 120-8 are upstream of the text node 130-3, data from these upstream visualization nodes (e.g., source nodes) flow to the text node 130-3 and provide the basis of subsequent visualizations that are generated.

In some embodiments, user interaction with text in a text node causes Data Weaver to query the language model 260 to suggest further analysis and supporting visualizations in accordance with the user-interacted text and reference datasets from the underlying source nodes, the user can select charts that may be relevant and add it to the canvas. this completes the text to viz to text bidirectional narrative cycle. FIG. 7B illustrates that, in response to the user interaction with the portion 708 of the text, the user interface 110 displays, in the insight cart 114, visual insights generated by the language model. In some embodiments, each of the visual insights includes a respective chart, such as charts 712, 714, and 716.

FIG. 7C illustrates that, in response to user selection of the chart 714, the user interface 110 renders a new visualization node 120-9 and displays the chart 714 in the new visualization node 120-9. The visualization node 120-9 is connected to the text node 130 via connector 140-9. Because the visualization node 120-9 is positioned upstream of the text node 130-3, data from the chart 714 flows to the text node 130-3, which can be used for generating additional data narratives. In some embodiments, the user can select any portion of any chart that is displayed in the visualizations nodes 120-6 to 120-9 to generate additional text narratives as explained above with reference to FIGS. 5A to 5G.

### Data Story Synthesis

During the bidirectional generation process, the connection between annotated visualizations and generated text is automatically maintained. DataWeaver stores both the narrative text and the corresponding visualization specifications in a JSON structure. This connection enables users to adjust the sequence of the story without disrupting the synchronization between the textual content and the associated visualizations. On the review page, the created story is presented as nested text blocks. Users can use drag-and-drop or buttons to rapidly reorder the final content and preview them in various formats.

FIGS. 8A to 8C are screenshots illustrating the review capabilities of Data Weaver in accordance with some embodiments.

During or upon completing the composition of the data story, authors can utilize a review page 810 of the user interface 110, as illustrated in FIG. 8A, to adjust the order of the content (e.g., by dragging individual paragraphs 812 and re-arranging them) and preview the final output in various forms. The adjusting mode automatically processes text from different nodes into a nested structure, enabling efficient restructuring of both the narrative and the linked visualizations. The previewing mode allows for a preview of the final product in common narrative visualization formats, including a continuous page, scrolly-telling format in FIG. 8B, a stepper format as illustrated in FIG. 8C, or as a static PDF.

### Flowcharts

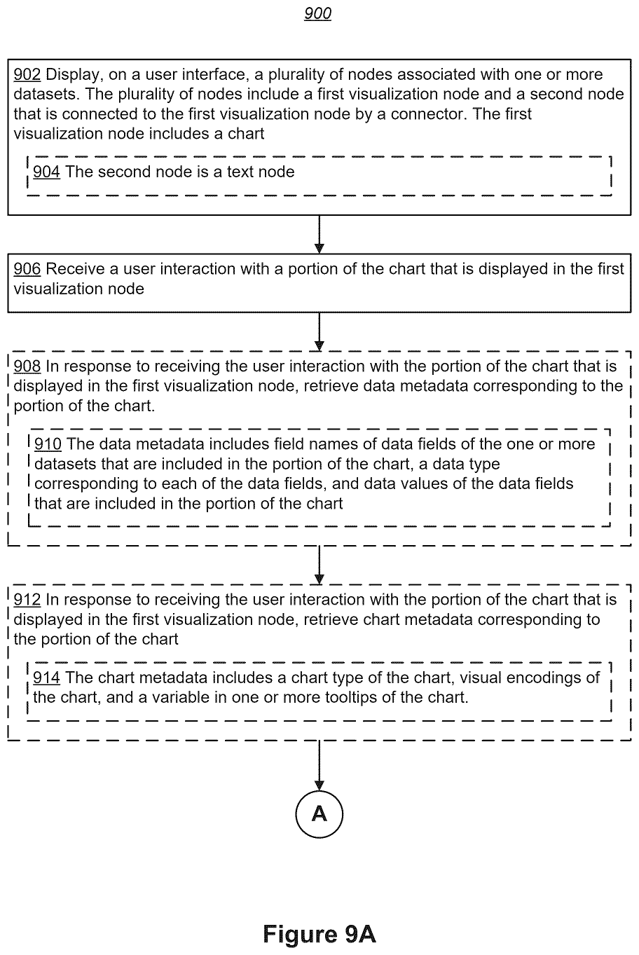

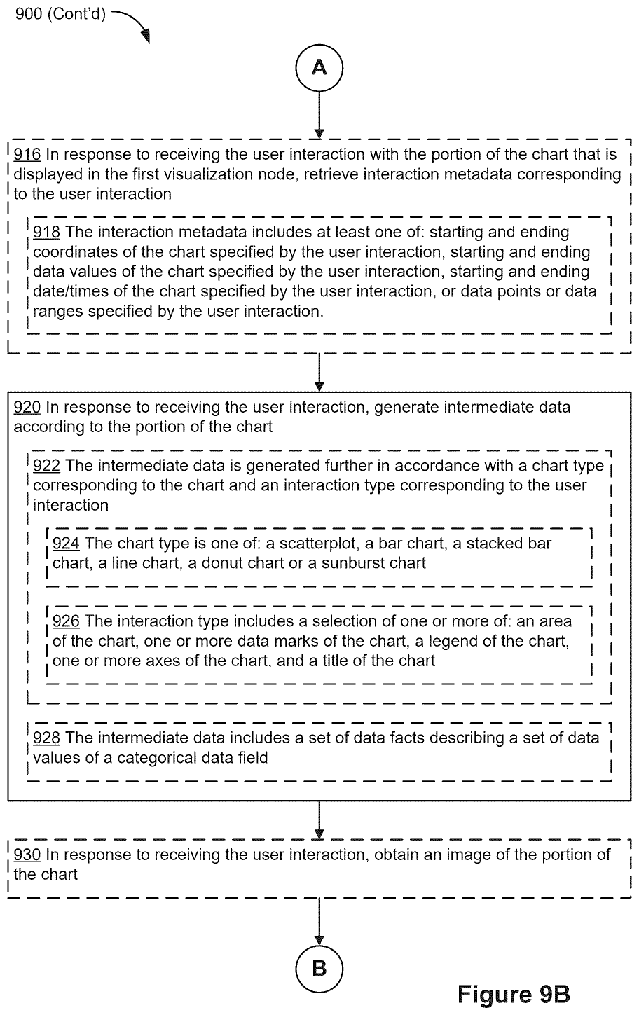

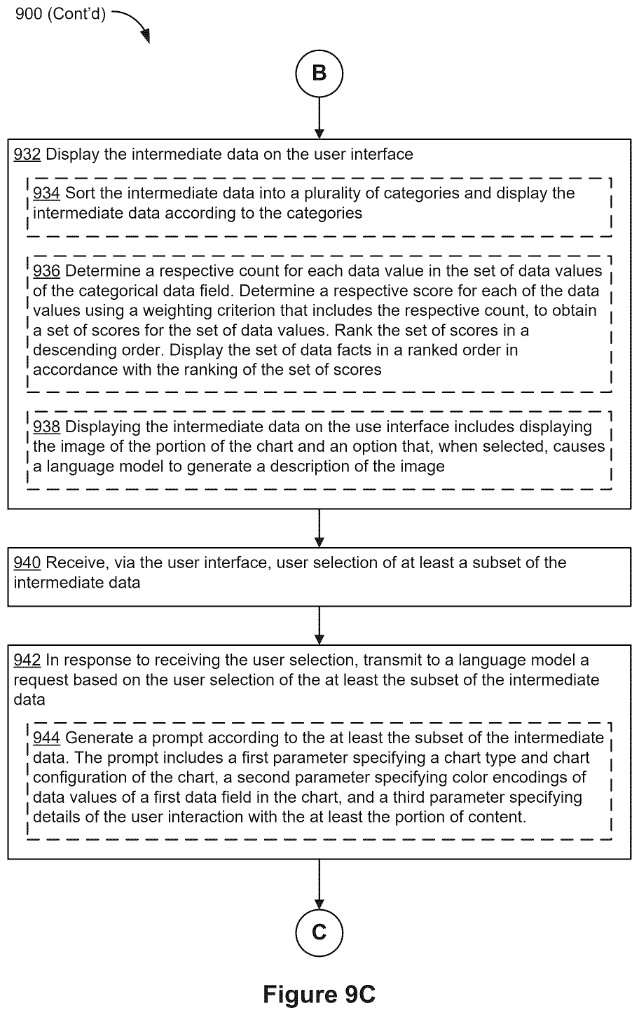

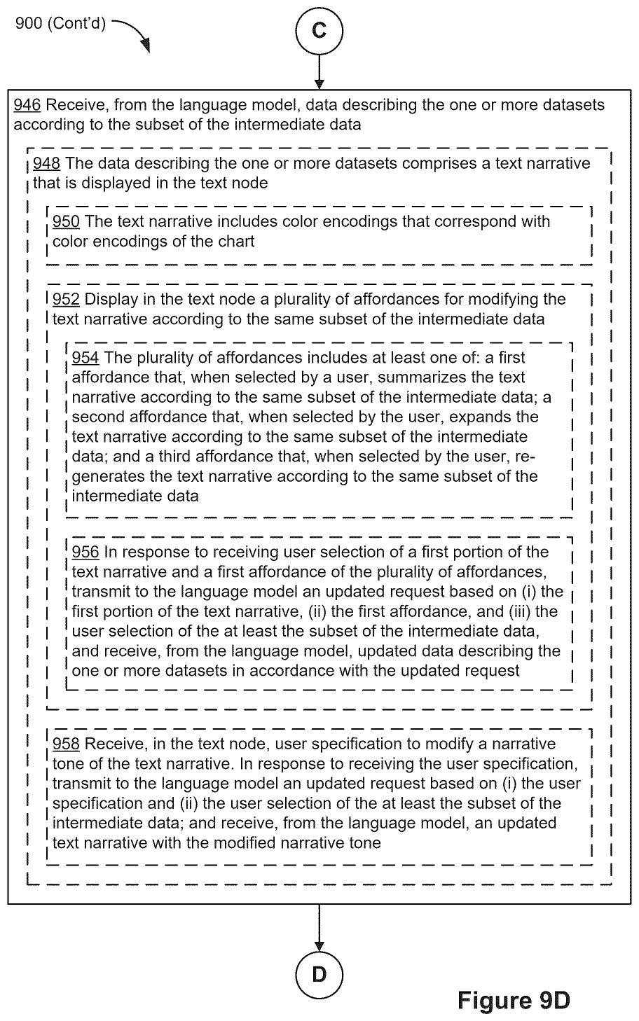

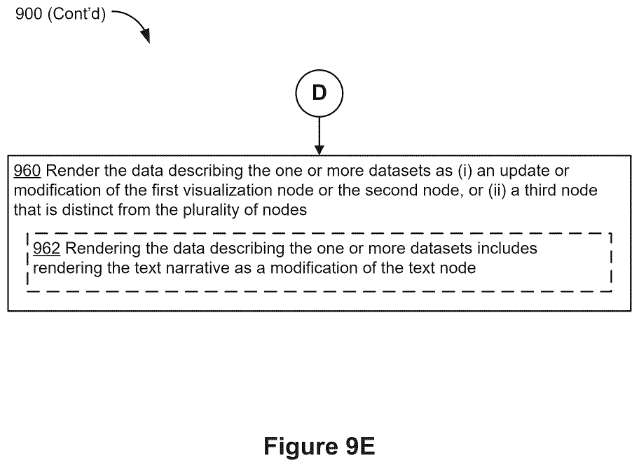

FIGS. 9A to 9E provide a flowchart of an example process for generating data narratives, in accordance with some embodiments. The method 900 is performed at a computing device (e.g., computing device 200) that includes a display (e.g., display 212, a display device or a display generation component), one or more processors 202, and memory 206. The memory stores one or more programs configured for execution by the one or more processors. In some embodiments, the operations shown in FIGS. 1A-1F, 2, 3, 4A-4D, 5A-5G, 6A-6D, 7A-7C, 8A-8C, 11A-11B, and 12A-12D correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 900 may be combined with the operations in the method 1000 and/or the order of some operations may be changed.

Referring to FIG. 9A, the computing device displays (902), on a user interface (e.g., user interface 110), a plurality of nodes associated with one or more datasets. The plurality of nodes includes a first visualization node (e.g., visualization node 120-2 in FIG. 5A) and a second node (e.g., text node 130-2) that is connected to the first visualization node by a connector (e.g., connector 140, or an edge). The first visualization node includes a chart (e.g., a data visualization). For example, FIG. 5A illustrates that the visualization node 120-2 displays a scatter plot 502. In some embodiments, the first visualization node can display a text table or a data dashboard that includes at least two charts.

In some embodiments, the second node is (904) a text node (e.g., text node 130-2 in FIG. 5A). In some embodiments, the second node is another visualization node that is connected to the first visualization node via a connector.

The computing device receives (906) a user interaction with a portion of the chart that is displayed in the first visualization node. As one example, FIG. 5C illustrates a user interaction (e.g., a 2-D brush over interaction) with a region 514 of the scatter plot 502 (e.g., chart). As another example, FIG. 5D illustrates a user interaction (e.g., discrete clicks or selection) of data bars 516 (e.g., data marks) of chart 504. In some embodiments, the user interaction includes user selection of the portion of the chart that is displayed in the first visualization node. The portion of the chart can include one or more data marks, an area of the chart, a title of the chart, an axis of the chart, or a legend of the chart.

In some embodiments, the computing device, in response to receiving the user interaction with the portion of the chart that is displayed in the first visualization node, retrieves (908) data metadata corresponding to the portion of the chart. The data metadata includes (910) field names (e.g., attribute names) of data fields of the one or more datasets that are included in the portion of the chart; a data type corresponding to each of the data fields; and data values of the data fields that are included in the portion of the chart. Exemplary data types of data fields include categorical data fields (e.g., dimension data fields), quantitative data fields (e.g., measure data fields), date/time fields, string data fields, integer data fields, character fields, or Boolean data fields

In some embodiments, the computing device, in response to receiving the user interaction with the portion of the chart that is displayed in the first node, retrieves (912) chart metadata corresponding to the portion of the chart. The chart metadata includes (914) a chart type of the chart; visual encodings of the chart, and a variable in one or more tooltips of the chart.

For example, the visual encodings can include encodings that specify the x-axis and y-axis of the chart, color encodings of data marks of the chart, and size encodings specifying a size of data marks of the chart. The visual encodings can vary depending on the chart type, in accordance with some embodiments. For example, DataWeaver places variables that are visually mapped (e.g., x and y values for a scatterplot) and identity variables (e.g., a country's name or a movie's title) in the tooltips.

Referring to FIG. 9B, in some embodiments, the computing device, in response to receiving the user interaction with the portion of the chart that is displayed in the first node, retrieves (916) interaction metadata corresponding to the user interaction. The interaction metadata includes (918) at least one of: starting and ending coordinates of the chart specified by the user interaction (e.g., identified by pixel numbers); or starting and ending data values of the chart specified by the user interaction; or starting and ending date/times of the chart specified by the user interaction; or data points or data ranges specified by the user interaction.

The computing device, in response to receiving the user interaction, generates (920) intermediate data (e.g., data facts) according to the portion of the chart.

In some embodiments, the intermediate data is (922) generated further in accordance with a chart type corresponding to the chart and an interaction type corresponding to the user interaction. For example, in some embodiments, the computing device applies a callout intent framework 159 that specifies a respective set of data facts to be generated (e.g., by the computing device) based on a specific callout interaction for a specific chart type, as described in FIGS. 4A and 4B. In some embodiments, the computing device, after recording (e.g., registering or determining) the interactions, extracts the relevant data facts and statistics associated with those interactions. For example, if a user brushes a region on a scatter plot, the computing device (e.g., executing Data Weaver or application 230) calculates the range of values within that brushed region and contrasts it with the overall data range. Similarly, when a user clicks on specific data points, the computing device identifies these points and retrieves relevant attributes or values.

In some embodiments, the chart type is (924) one of: a scatterplot, a bar chart, a stacked bar chart, a line chart, a donut chart or a sunburst chart. This is illustrated in FIGS. 4A and 4B.

In some embodiments, the interaction type includes (926) a selection of one or more of: an area of the chart (e.g., a 2-D brush), one or more data marks of the chart (e.g., discrete selection, user clicks), a legend of the chart, one or more axes of the chart, and a title of the chart.

In some embodiments, the intermediate data includes (928) a set of data facts describing a set of data values of a categorical data field. For example, FIG. 4C shows “mode data facts” describing data values “Africa” and “Europe” for the data field “Continent.”

In some embodiments, the computing device, in response to receiving the user interaction, obtains (930) (e.g., retrieves, extracts, or generates) an image (e.g., a “screenshot”, a png image a .tif image, or a pdf) of the portion of the chart.

Referring now to FIG. 9C, the computing device displays (932) the intermediate data on the user interface (e.g., in an insight cart 114 region of the user interface 110).

In some embodiments, displaying the intermediate data on the user interface includes sorting (934) the intermediate data into a plurality of categories and displaying the intermediate data according to the categories.

In some embodiments, displaying the intermediate data on the user interface includes determining (936) a respective count (frequency) for each data value in the set of data values. The computing device also determines a respective score for each of the data values using a weighting criterion that includes the respective count (Wi, which accounts for normalized differences, ratios, and entropy), to obtain a set of scores for the set of data values, and ranks the set of scores in a descending order. The computing device displays the set of data facts in a ranked order in accordance with the ranking of the set of scores.

In some embodiments, displaying the intermediate data on the use interface includes displaying (938) the image of the portion of content and an option that, when selected, causes the language model to generate a description of the image.

The computing device receives (940), via the user interface, user selection of at least a subset of the intermediate data. This is illustrated in FIGS. 5D, 5E, and 5F.

The computing device, in response to receiving the user selection, transmits (942) to a language model (e.g., language model application 260 or language model web application 360) a request based on the user selection of the at least the subset of the intermediate data.

In some embodiments, transmitting the request to the language model includes generating (944), by the computing device, a prompt according to the at least the subset of the intermediate data. The prompt includes a first parameter specifying a chart type (e.g., scatterplot, bar chart, or line chart) and chart configuration (e.g., axis labels, title, font type, font size, data series, or color encodings) of the chart; a second parameter specifying color encodings of data values of a first data field in the chart; and a third parameter specifying details of the user interaction with the at least the portion of content. For example, FIG. 11A shows a template for a visualization-to-text prompt that is generated by the computing device. FIGS. 11B-1 and 11B-2 are visualization-to-text prompt templates for specific charts that are generated by the computing device in accordance with some embodiments.

In some embodiments, for each chart and interaction pair, a user can select multiple corresponding data facts and statistics for narrative generation. The selected data facts, which may include specific values, ranges, or statistical summaries, are gathered and organized based on the user's interactions with the visualization. This process is facilitated by the callout state, which records user interactions such as brushing, clicking, or using the legend to filter data. Once these interactions are recorded, the system extracts the relevant data facts and statistics associated with those interactions. For example, if a user brushes a region on a scatter plot, the system calculates the range of values within that brushed region and contrasts it with the overall data range. Similarly, when a user clicks on specific data points, the system identifies these points and retrieves relevant attributes or values, which are then passed as part of the callout description text. These selected data facts are then compiled into a structured format that includes key attributes such as X-axis and Y-axis values, specific data points of interest, and any interaction metadata (e.g., brushed ranges, selected groups, or clicked values). This structured data is embedded within a contextual narrative prompt, guiding the language model (e.g., language model application 260, such as GPT) to synthesize a coherent and meaningful narrative that accurately reflects the insights derived from the visualization.

In the final prompt, these data facts are presented alongside the visualization context, interaction details, and any additional descriptive elements. GPT uses this comprehensive input to generate a narrative that is both data-driven and contextually relevant, ensuring that all selected data facts are seamlessly integrated into the narrative output. This approach allows for the dynamic generation of narratives that are tailored to the specific interactions and insights identified by the user.

As an example, the prompt content of a prompt template used to generate a narrative for a brushed scatterplot includes:
1. Chart Type and Configuration
   Chart type: Scatterplot
   Scatterplot configuration:
      Color attribute: Continent
      Identity attribute: Country
      Size attribute: Population
      X-axis attribute: GDP per Capita (gdpPercap)
      Y-axis attribute: Life Expectancy (lifeExp)
2. Visualization Analysis
   Color mapping:
      Africa: #4269d0
      Americas: #efb118
      Asia: #ff725c
      Europe: #6cc5b0
      Oceania: #3ca951
3. Context Comprehension
   Article context:
      Mapping Prosperity: Unearthing the Economic Pulse of African Countries African countries face significant challenges in their pursuit of development and stability, from economic hardships and health crises to environmental issues. Despite these challenges, countries across the continent are working towards economic growth and improving the quality of life for their citizens.
   Specific context: Write a narrative for a scatter plot. X-axis attribute: GDP per Capita, Y-axis attribute: Life Expectancy.
   Interactions highlighting visual elements:
      I brushed a region in the scatterplot. Here's the brushed range: X: 0 to 16,307.575, Y: 61.308 to 38.436. The full range is X: 277.551 to 49,357.190, Y: 39.613 to 82.603.
4. Data Insights
   91.11% (41 occurrences) of the selected data points have the attribute “Continent=Africa.” (commonality)
   The average GDP per Capita is 2,433.07. (report statistics)
   The maximum GDP per Capita is 13,206.48. (report statistics)
   Congo, Dem. Rep. is ranked 142nd out of 142 in GDP per Capita. (rank)
   Swaziland is ranked 142nd out of 142 in Life Expectancy. (rank)
5. Narrative Synthesis
   Weave together the selected data facts with the visualization and context, without providing a conclusion.
6. Sentence Crafting
   Write concise, relevant sentences that adhere to the selected data facts and image input, ensuring all data facts are included.
   Ensure the narrative transitions seamlessly from the preceding article context.
   Do not repeat the previous context.
   Include HTML snippets for accurate color mapping.
   Output only the newly created data sentences, ensuring precision.

In some embodiments, the language model synthesizes the information provided in the prompt template by following a structured approach that aligns with the components outlined in the template.
Chart Type and Configuration: Specifies the type of chart (scatterplot) and its relevant attributes, including X and Y axes, color, size, and identity attributes.
Visualization Analysis: Describes the color mapping and other visual attributes, setting the stage for the narrative.
Context Comprehension: Provides the broader article context and specific context relevant to the visualization, helping GPT understand the narrative's purpose.
Interaction Details: Captures user interactions with the visualization, such as brushing, which influence the focus of the narrative.
Data Insights: Lists the key data facts and statistics derived from the visualization, which will be the core content of the narrative.
Narrative Synthesis: Guides GPT in integrating the selected data facts into a coherent narrative that aligns with the visualization and context, without introducing new conclusions.
Sentence Crafting: Provides instructions for generating concise and contextually integrated sentences, with specific attention to HTML color mapping for visual elements.

With continued reference to FIG. 9D, the computing device receives (946), from the language model, data describing the one or more datasets according to the subset of the intermediate data selected by the user.

In some embodiments, the data describing the one or more datasets comprises (948) a text narrative that is displayed in the text node. For example, FIG. 5G shows that the data describing the one or more datasets comprises text narratives in the form of additional paragraphs 528 and 530 that are displayed in the text node 130-2.

In some embodiments, the text narrative includes (950) color encodings that correspond with (e.g., match, are the same as) color encodings of the chart (e.g., the color encodings of the text narrative are the same as the color encodings of the chart). For example, FIG. 5G shows that portions of the text narrative that describe data values (e.g., continents) such as “Africa,” “Oceania,” and “Asia” are color-coded according to the same color encodings of the source charts 502 and 504 (see FIGS. 5B and 5C).

In some embodiments, the computing device displays (952) in the text node a plurality of affordances (e.g., user-selectable options or icons) for modifying the data narrative according to the same subset of the intermediate data. This is illustrated in FIG. 6A.

In some embodiments, the plurality of affordances includes (954) at least one of: a first affordance (e.g., affordance 602) that, when selected by a user, summarizes (e.g., reduces a length of) the text narrative according to the same subset of the intermediate data; a second affordance (e.g., affordance 604) that, when selected by the user, expands the text narrative according to the same subset of the intermediate data; and a third affordance (e.g., affordance 606) that, when selected by the user, re-generates the text narrative according to the same subset of the intermediate data. This is illustrated in FIG. 6A.

In some embodiments, the computing device, in response to receiving user selection of a first portion of the text narrative and a first affordance of the plurality of affordances, transmits (956) to the language model an updated request based on (i) the first portion of the text narrative, (ii) the first affordance, and (iii) the user selection of the at least the subset of the intermediate data. The computing device receives, from the language model, updated data describing the one or more datasets in accordance with the updated request.

For example, in some embodiments, each of the affordances is pre-configured with a respective set of instructions. User selection of the first portion of the text narrative and the first affordance causes the instructions to be integrated into a new prompt alongside the generated content and the original prompt to ensure that the new content accurately aligns with the data facts.

In some embodiments, the computing device receives (958), in the text node, user specification (e.g., via an input box 612 that is illustrated in FIG. 6A) to modify a narrative tone of the text narrative. The computing device, in response to receiving the user specification, transmits to the language model an updated request based on (i) the user specification and (ii) the user selection of the at least the subset of the intermediate data. The computing device receives, from the language model, an updated text narrative with the modified narrative tone.

For example, the user can specify the name of a person or character that they would like the data narrative to sound like (e.g., “Say it like you are Nelson Mandela”), or switch from a first-person narrative to a third person narrative. As another example, a user can also ask DataWeaver to refrain from using certain words and phrases, or rephrase certain terms in the text narratives, such as describing data as ratios or percentages instead of absolute numbers as illustrated in the example of FIGS. 6C and 6D.

Referring to FIG. 9E, the computing device renders (960) the data describing the one or more datasets as (i) an update or modification of the first visualization node or the second node (e.g., update or modification of existing content that is displayed in the first node or second node), or (ii) a third node that is distinct from the plurality of nodes.

In some embodiments, rendering the data describing the one or more datasets includes rendering (962) the text narrative as a modification of the text node. For example, in some embodiments, the modification of the text node includes adding one or more paragraphs of content to existing content in the text node, such as additional paragraphs 528 and 530 as illustrated in FIG. 5G.

Although FIGS. 9A to 9E illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

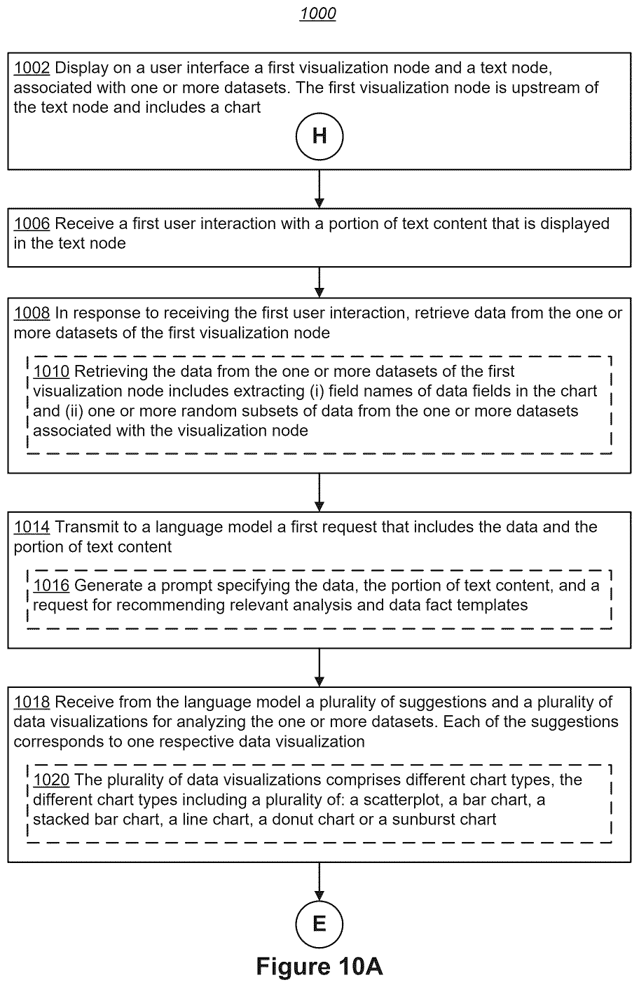

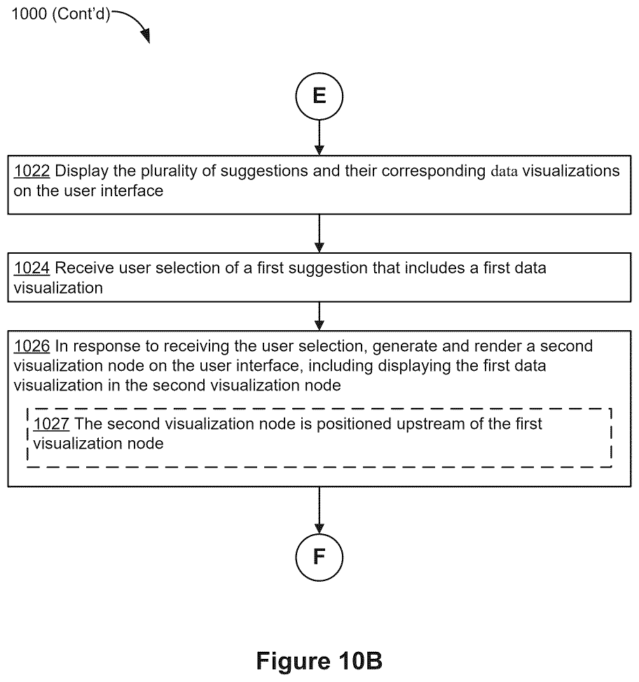

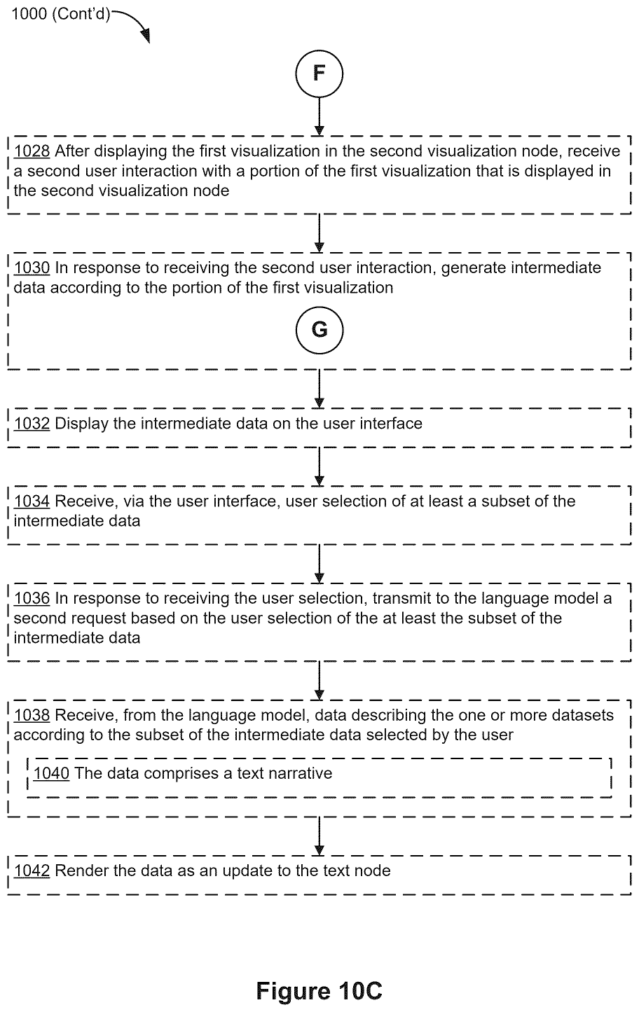

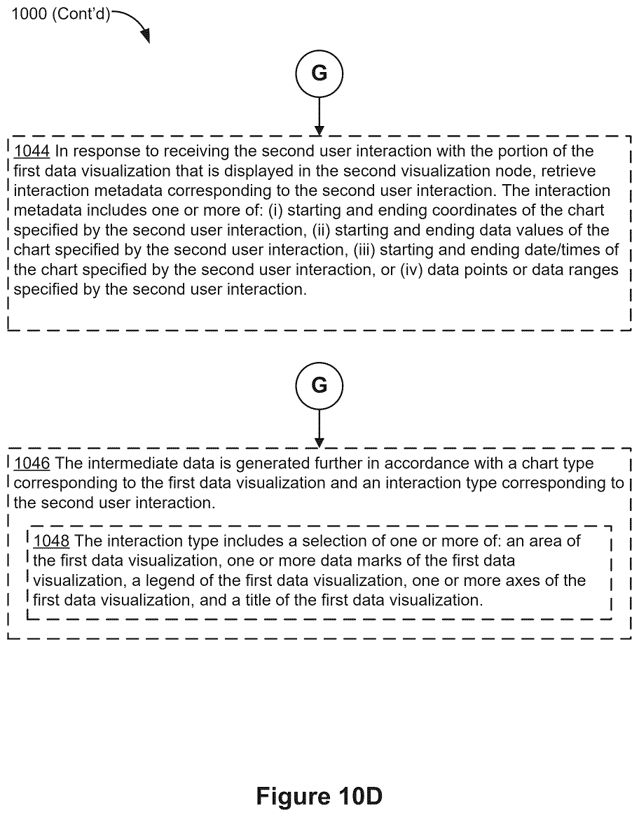

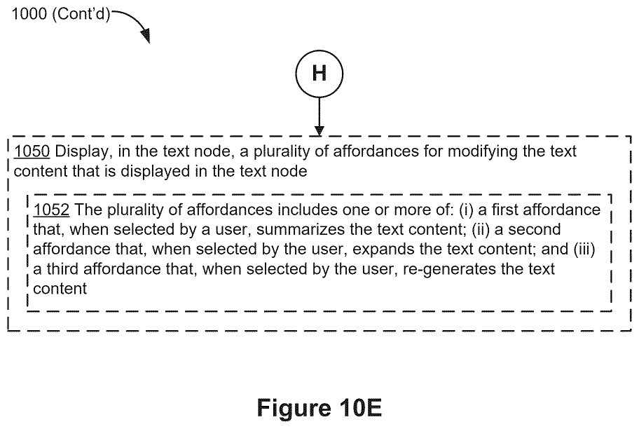

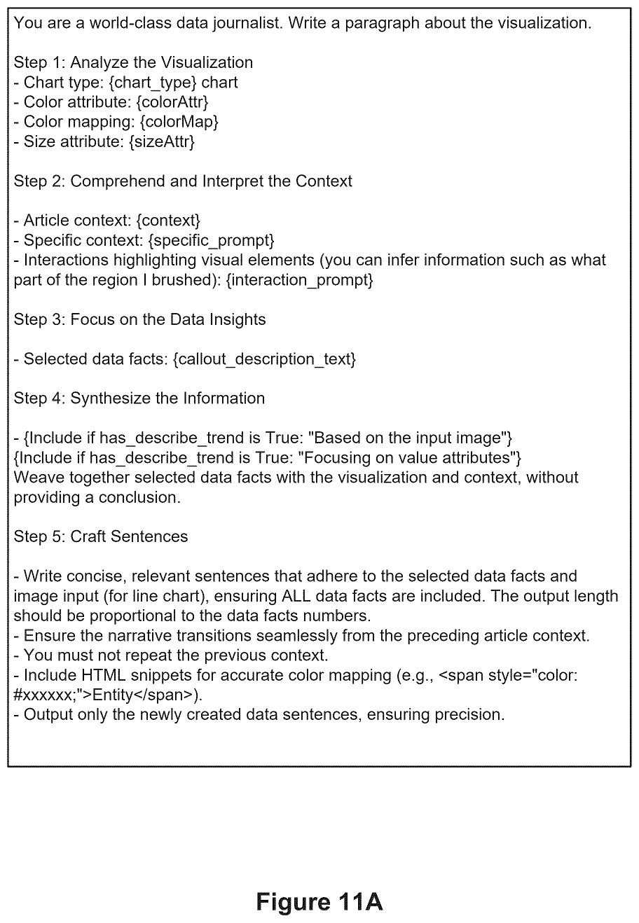

FIGS. 10A to 10E provide a flowchart of an example process for generating data narratives, in accordance with some embodiments. The method 1000 is performed at a computing device (e.g., computing device 200) that includes a display (e.g., display 212, a display device or a display generation component), one or more processors 202, and memory 206. The memory stores one or more programs configured for execution by the one or more processors. In some embodiments, the operations shown in FIGS. 1A-1F, 2, 3, 4A-4D, 5A-5G, 6A-6D, 7A-7C, 8A-8C, 11A-11B, and 12A-12D correspond to instructions stored in the memory 206 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1000 may be combined with the operations in the method 900 and/or the order of some operations may be changed.

Referring to FIG. 10A, the computing device displays (1002), on a user interface (e.g., user interface 110), a first visualization node (e.g., visualization node 120-6, 120-7, or 120-8 in FIG. 7A) and a text node (e.g., text node 130-3) associated with one or more datasets (e.g., datasets or data sources 240). The first visualization node is upstream of the text node, such that data flows from the upstream viz node to the downstream text node. This is illustrated in FIG. 7A. The first visualization node includes a chart. For example, in FIG. 7A, visualization node 120-6 includes a chart 702, visualization node 120-7 includes a chart 704, visualization node 120-8 includes a chart 702. The first visualization node and the text node connected by a connector (e.g., connector 140, or an edge).

The computing device receives (1006) a user interaction with a portion of text content that is displayed in the text node. For example, in FIG. 7A, the computing device receives a user interaction with a portion 708 of the text content that is displayed in the text node 130-3.

The computing device, in response to receiving the user interaction, retrieves (1008) data from the one or more datasets of the first visualization node.

In some embodiments, retrieving data from the one or more datasets of the first visualization node includes (1010) (i) extracting field names of data fields in the chart and (ii) one or more random subsets of data from the one or more datasets associated with the visualization node. For example, in some embodiments, the computing device randomly samples the datasets (i.e., randomly samples the data from the subsets) to extract, for each dataset, a random subset of data.

The computing device transmits (1014) to a language model (e.g., language model application 260 or language model web application 360) a first request that includes the data and the portion of text content.

In some embodiments, transmitting the request to the language model includes generating (1016), by the computing device, a prompt specifying the data, metadata, the portion of text content (e.g., focused text), and a request for recommending relevant analysis and data fact templates. As one example, FIG. 12A shows a text-to-visualization template generated by the computing device for input into a LLM, in accordance with some embodiments. As another example, FIG. 12B shows a text-to-visualization prompt template generated by the computing device for input into a LLM, in accordance with some embodiments.

The computing device receives (1018) from the language model a plurality of suggestions and a plurality of data visualizations (e.g., visual insights) for analyzing the one or more datasets. Each of the suggestions corresponds to one respective data visualization.

In some embodiments, the plurality of data visualizations comprises (1020) different chart types. In some embodiments, the different chart types include a plurality of: a scatterplot, a bar chart, a stacked bar chart, a line chart, a donut chart or a sunburst chart.

Referring to FIG. 10B, the computing device displays (1022) the plurality of suggestions and their corresponding data visualizations on the user interface. For example, in FIG. 7B, the computing device displays the visualizations (e.g., charts) 712, 714, and 716.

The computing device receives (1024) user selection of a first suggestion that includes a first data visualization. For example, in FIG. 7B, the computing device receives user selection of the chart 714.

The computing device, in response to receiving the user selection, generates (1026) and renders a second visualization node (e.g., visualization node 120-9 in FIG. 7C) on the user interface, including displaying the first visualization (e.g., chart 714) in the second visualization node.

In some embodiments, the second visualization node is positioned (1027) upstream of the first visualization node. This is illustrated in FIG. 7C.

In some embodiments, the second visualization node can be used by the computing device to generate updates to the text narrative, as explained above with respect to the examples in FIGS. 5A to 5G.

Referring to FIG. 10C, in some embodiments, the computing device, after displaying the first visualization in the second visualization node, receives (1028) a user interaction with a portion of the first data visualization that is displayed in the second visualization node.

In some embodiments, the computing device, in response to receiving the user interaction, generates (1030) intermediate data according to the portion of the first visualization.

In some embodiments, the computing device displays (1032) the intermediate data on the user interface (e.g., in the insight cart 114).

In some embodiments, the computing device receives (1034), via the user interface, user selection of at least a subset of the intermediate data.

In some embodiments, the computing device, in response to receiving the user selection, transmits (1036) to the language model a second request based on the user selection of the at least the subset of the intermediate data and receives (1038), from the language model, data describing the one or more datasets according to the subset of the intermediate data selected by the user.

In some embodiments, the data comprises (1040) (e.g., is or includes) a text narrative.

In some embodiments, the computing device renders (1042) the data as an update to the text node.

With continued reference to FIG. 10D, in some embodiments, in response to receiving the second user interaction with the portion of the first data visualization that is displayed in the second visualization node, the computing device retrieves (1044) interaction metadata corresponding to the second user interaction. In some embodiments, the interaction metadata includes one or more of: (i) starting and ending coordinates of the chart specified by the second user interaction; or (ii) starting and ending data values of the chart specified by the second user interaction; or (iii) starting and ending date/times of the chart specified by the second user interaction; or (iv) data points or data ranges specified by the second user interaction.

In some embodiments, the intermediate data is generated (1046) further in accordance with a chart type corresponding to the first data visualization and an interaction type corresponding to the second user interaction.

In some embodiments, the interaction type includes (1048) a selection of one or more of: an area of the first data visualization, one or more data marks of the first data visualization, a legend of the first data visualization, one or more axes of the first data visualization, and a title of the first data visualization.

Referring to FIG. 10E, in some embodiments, the computing device displays (1050), in the text node, a plurality of affordances (e.g., affordances 602, 604, and 606) for modifying the text content that is displayed in the text node. In some embodiments, the plurality of affordances includes (1052) one or more of: (i) a first affordance that, when selected by a user, summarizes the text content; (ii) a second affordance that, when selected by the user, expands the text content; and (iii) a third affordance that, when selected by the user, re-generates the text content.

Although FIGS. 10A to 10E illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:

(A1) In accordance with some embodiments, a method of generating data narratives is performed at a computing device that includes a display, one or more processors, and memory. The method includes (1) displaying, on a user interface, a plurality of nodes associated with one or more datasets, the plurality of nodes including a first visualization node and a second node that is connected to the first visualization node by a connector, the first visualization node including a chart; (2) receiving a user interaction with a portion of the chart that is displayed in the first visualization node; (3) in response to receiving the user interaction: (a) generating intermediate data according to the portion of the chart; and (b) displaying the intermediate data on the user interface; (4) receiving, via the user interface, user selection of at least a subset of the intermediate data; and (5) in response to receiving the user selection: (a) transmitting to a language model a request based on the user selection of the at least the subset of the intermediate data; and (b) receiving, from the language model, data describing the one or more datasets according to the subset of the intermediate data; and (6) rendering the data describing the one or more datasets as (i) an update or modification of the first visualization node or the second node, or (ii) a third node that is distinct from the plurality of nodes.

(A2) In some embodiments of A1, the method includes: in response to receiving the user interaction with the portion of the chart that is displayed in the first visualization node, retrieving data metadata corresponding to the portion of the chart, including: (i) field names of data fields of the one or more datasets that are included in the portion of the chart; (ii) a data type corresponding to each of the data fields; and (iii) data values of the data fields that are included in the portion of the chart.

(A3) In some embodiments of A1 or A2, the method includes: in response to receiving the user interaction with the portion of the chart that is displayed in the first visualization node, retrieving chart metadata corresponding to the portion of the chart, including: (i) a chart type of the chart; (ii) visual encodings of the chart; and (iii) a variable in one or more tooltips of the chart.

(A4) In some embodiments of any of A1-A3, the method further includes: in response to receiving the user interaction with the portion of the chart that is displayed in the first visualization node, retrieving interaction metadata corresponding to the user interaction, including: (i) starting and ending coordinates of the chart specified by the user interaction; or (ii) starting and ending data values of the chart specified by the user interaction; or (iii) starting and ending date/times of the chart specified by the user interaction; or (iv) data points or data ranges specified by the user interaction.

(A5) In some embodiments of any of A1-A4, the intermediate data is generated further in accordance with (i) a chart type corresponding to the chart and (ii) an interaction type corresponding to the user interaction.

(A6) In some embodiments of A5, the chart type is one of: a scatterplot, a bar chart, a stacked bar chart, a line chart, a donut chart or a sunburst chart.

(A7) In some embodiments of A5 or A6, the interaction type includes a selection of one or more of: an area of the chart, one or more data marks of the chart, a legend of the chart, one or more axes of the chart, and a title of the chart.

(A8) In some embodiments of any of A1-A7, displaying the intermediate data on the user interface includes sorting the intermediate data into a plurality of categories and displaying the intermediate data according to the categories.

(A9) In some embodiments of any of A1-A8, the intermediate data includes a set of data facts describing a set of data values of a categorical data field. Displaying the intermediate data on the user interface includes: (i) determining a respective count for each data value in the set of data values; (ii) determining a respective score for each of the data values using a weighting criterion that includes the respective count, to obtain a set of scores for the set of data values; and (iii) ranking the set of scores in a descending order. The method includes displaying the set of data facts in a ranked order in accordance with the ranking of the set of scores.

(A10) In some embodiments of any of A1-A9, transmitting the request to the language model includes generating a prompt according to the at least the subset of the intermediate data, the prompt including: (i) a first parameter specifying a chart type and chart configuration of the chart; (ii) a second parameter specifying color encodings of data values of a first data field in the chart; and (iii) a third parameter specifying details of the user interaction with the at least the portion of content.

(A11) In some embodiments of any of A1-A10, the second node is a text node; and the data describing the one or more datasets comprises a text narrative.

(A12) In some embodiments of A11, rendering the data describing the one or more datasets includes rendering the text narrative as a modification of the text node.

(A13) In some embodiments of A11 or claim A12, the text narrative includes color encodings that correspond with color encodings of the chart.

(A14) In some embodiments of A11-A13, the method includes displaying in the text node a plurality of affordances for modifying the text narrative according to the same subset of the intermediate data.

(A15) In some embodiments of A14, the plurality of affordances includes one or more of: (i) a first affordance that, when selected by a user, summarizes the text narrative according to the same subset of the intermediate data; (ii) a second affordance that, when selected by the user, expands the text narrative according to the same subset of the intermediate data; and (iii) a third affordance that, when selected by the user, re-generates the text narrative according to the same subset of the intermediate data.

(A16) In some embodiments of A14 or A15, the method includes: in response to receiving user selection of a first portion of the text narrative and a first affordance of the plurality of affordances: transmitting to the language model an updated request based on (i) the first portion of the text narrative, (ii) the first affordance, and (iii) the user selection of the at least the subset of the intermediate data; and receiving, from the language model, updated data describing the one or more datasets in accordance with the updated request.

(A17) In some embodiments of any of A11-A16, the method includes: receiving, in the text node, user specification to modify a narrative tone of the text narrative; and in response to receiving the user specification, transmitting to the language model an updated request based on (i) the user specification and (ii) the user selection of the at least the subset of the intermediate data; and receiving, from the language model, an updated text narrative with the modified narrative tone.

(A18) In some embodiments of any of A1-A17, the method includes: in response to receiving the user interaction, obtaining an image of the portion of content, wherein displaying the intermediate data on the use interface includes displaying the image of the portion of content and an option that, when selected, causes the language model to generate a description of the image.

(B1) In accordance with some embodiments, a method for generating data narratives is performed at a computing device that includes a display, one or more processors, and memory. The method includes (1) displaying on a user interface a first visualization node and a text node, associated with one or more datasets, wherein the first visualization node is upstream of the text node and includes a chart; (2) receiving a first user interaction with a portion of text content that is displayed in the text node; (3) in response to receiving the first user interaction: (a) retrieving, from the one or more datasets, data of the first visualization node; (b) transmitting to a language model a first request that includes the data and the portion of text content; (c) receiving from the language model a plurality of suggestions and a plurality of visualizations for analyzing the one or more datasets, each of the suggestions corresponding to one respective data visualization; and (d) displaying the plurality of suggestions and their corresponding data visualizations on the user interface; (4) receiving user selection of a first suggestion that includes a first data visualization; and (5) in response to receiving the user selection: generating and rendering a second visualization node on the user interface, including displaying the first data visualization in the second visualization node.

(B2) In some embodiments of B1, retrieving, from the one or more datasets, data of the first visualization node includes extracting (i) field names of data fields in the chart and (ii) one or more random subsets of data from the one or more datasets associated with the visualization node.

(B3) In some embodiments of B1 or B2, transmitting the request to the language model includes generating, by the computing device, a prompt specifying (i) the data, (ii) the portion of text content, and (iii) a request for recommending relevant analysis and data fact templates.

(B4) In some embodiments of any of B1-B3, the second visualization node is positioned upstream of the first visualization node.

(B5) In some embodiments of any of B1-B4, the method includes after displaying the first data visualization in the second visualization node: (1) receiving a second user interaction with a portion of the first visualization that is displayed in the second visualization node; (2) in response to receiving the second user interaction: (i) generating intermediate data according to the portion of the first data visualization; and (ii) displaying the intermediate data on the user interface; (3) receiving, via the user interface, user selection of at least a subset of the intermediate data; and (4) in response to receiving the user selection: (i) transmitting to the language model a second request based on the user selection of the at least the subset of the intermediate data; and (ii) receiving, from the language model, data describing the one or more datasets according to the subset of the intermediate data selected by the user; and (5) rendering the data as an update to the text node.

(B6) In some embodiments of B5, the data is a text narrative.

(B7) In some embodiments of B5 or B6, the method further includes, in response to receiving the second user interaction with the portion of the first data visualization that is displayed in the second visualization node, retrieving interaction metadata corresponding to the second user interaction, including: (i) starting and ending coordinates of the chart specified by the second user interaction; or (ii) starting and ending data values of the chart specified by the second user interaction; or (iii) starting and ending date/times of the chart specified by the second user interaction; or (iv) data points or data ranges specified by the second user interaction.

(B8) In some embodiments of any of B5-B7, the intermediate data is generated further in accordance with a chart type corresponding to the first data visualization and an interaction type corresponding to the second user interaction.

(B9) In some embodiments of B8, the interaction type includes a selection of one or more of: an area of the first data visualization, one or more data marks of the first data visualization, a legend of the first data visualization, one or more axes of the first data visualization, and a title of the first data visualization.

(B10) In some embodiments of any of B1-B9, the plurality of data visualizations comprises different chart types, the different chart types including a plurality of: a scatterplot, a bar chart, a stacked bar chart, a line chart, a donut chart or a sunburst chart.

(B11) In some embodiments of any of B1-B10, the method further includes displaying, in the text node, a plurality of affordances for modifying the text content that is displayed in the text node.

(B12) In some embodiments of B11, the plurality of affordances includes one or more of: (i) a first affordance that, when selected by a user, summarizes the text content; (ii) a second affordance that, when selected by the user, expands the text content; and (iii) a third affordance that, when selected by the user, re-generates the text content.

(C1) In accordance with some embodiments, a computing device comprises a display; one or more processors; and memory coupled to the one or more processors. The memory stores one or more programs configured for execution by the one or more processors. The one or more programs include instructions for performing the method of any of A1-A18 and B1-B12.

(D1) In accordance with some embodiments, a computer-readable medium stores one or more programs configured for execution by one or more processors of a computing device. The one or more programs include instructions for performing the method of any of A1-A18 and B1-B12.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for generating data narratives, performed at a computing device that includes a display, one or more processors, and memory, the method comprising:
displaying on a user interface a first visualization node and a text node, associated with one or more datasets, wherein the first visualization node is (i) upstream of the text node and (ii) includes a chart;
receiving a first user interaction with a portion of text content that is displayed in the text node;
in response to receiving the first user interaction:
retrieving, from the one or more datasets, data of the first visualization node;
transmitting to a language model a first request that includes the data and the portion of text content;
receiving from the language model a plurality of suggestions and a plurality of data visualizations for analyzing the one or more datasets, each of the suggestions corresponding to one respective data visualization; and
displaying the plurality of suggestions and their corresponding data visualizations on the user interface;
receiving user selection of a first suggestion that includes a first data visualization; and
in response to receiving the user selection:
generating and rendering a second visualization node on the user interface, including displaying the first data visualization in the second visualization node.

2. The method of claim 1, wherein retrieving, from the one or more datasets, data of the first visualization node includes:
extracting (i) field names of data fields in the chart and (ii) one or more random subsets of data from the one or more datasets associated with the visualization node, wherein the one or more random subsets comprise random samples of the one or more datasets.

3. The method of claim 1, wherein transmitting the first request to the language model includes:
generating a prompt specifying the data, the portion of text content, and a request for recommending relevant analysis and data fact templates.

4. The method of claim 1, wherein the second visualization node is positioned upstream of the first visualization node.

5. The method of claim 1, further comprising:
after displaying the first data visualization in the second visualization node:
receiving a second user interaction with a portion of the first data visualization that is displayed in the second visualization node;
in response to receiving the second user interaction:
generating intermediate data according to the portion of the first data visualization; and
displaying the intermediate data on the user interface;
receiving, via the user interface, user selection of at least a subset of the intermediate data; and
in response to receiving the user selection:
transmitting to the language model a second request based on the user selection of the at least the subset of the intermediate data; and
receiving, from the language model, data describing the one or more datasets according to the user selection of the at least the subset of the intermediate data; and
rendering the data as an update to the text node.

6. The method of claim 5, wherein the data is a text narrative.

7. The method of claim 5, further comprising:
in response to receiving the second user interaction with the portion of the first data visualization that is displayed in the second visualization node, retrieving interaction metadata corresponding to the second user interaction, including:
starting and ending coordinates of the chart specified by the second user interaction; or
starting and ending data values of the chart specified by the second user interaction; or
starting and ending date/times of the chart specified by the second user interaction; or
data points or data ranges specified by the second user interaction.

8. The method of claim 5, wherein the intermediate data is generated further in accordance with a chart type corresponding to the first data visualization and an interaction type corresponding to the second user interaction.

9. The method of claim 8, wherein the interaction type includes a selection of one or more of: an area of the first data visualization, one or more data marks of the first data visualization, a legend of the first data visualization, one or more axes of the first data visualization, and a title of the first data visualization.

10. The method of any of claim 1, wherein the plurality of data visualizations comprises different chart types, the different chart types including a plurality of: a scatterplot, a bar chart, a stacked bar chart, a line chart, a donut chart or a sunburst chart.

11. The method of claim 1, further comprising displaying, in the text node, a plurality of affordances for modifying the text content that is displayed in the text node.

12. The method of claim 11, wherein the plurality of affordances includes one or more of:
a first affordance that, when selected by a user, summarizes the text content;
a second affordance that, when selected by the user, expands the text content; and
a third affordance that, when selected by the user, re-generates the text content.

13. A computing device, comprising:
a display;
one or more processors; and
memory coupled to the one or more processors, the memory storing one or more programs configured for execution by the one or more processors, the one or more programs including instructions for:
displaying on a user interface a first visualization node and a text node, associated with one or more datasets, wherein the first visualization node is (i) upstream of the text node and (ii) includes a chart;
receiving a first user interaction with a portion of text content that is displayed in the text node;
in response to receiving the first user interaction:
retrieving, from the one or more datasets, data of the first visualization node;
transmitting to a language model a first request that includes the data and the portion of text content;
receiving from the language model a plurality of suggestions and a plurality of data visualizations for analyzing the one or more datasets, each of the suggestions corresponding to one respective data visualization; and
displaying the plurality of suggestions and their corresponding data visualizations on the user interface;
receiving user selection of a first suggestion that includes a first data visualization; and
in response to receiving the user selection:
generating and rendering a second visualization node on the user interface, including displaying the first data visualization in the second visualization node.

14. The computing device of claim 13, wherein the instructions for retrieving, from the one or more datasets, data of the first visualization node include instructions for:
extracting (i) field names of data fields in the chart and (ii) one or more random subsets of data from the one or more datasets associated with the visualization node, wherein the one or more random subsets comprise random samples of the one or more datasets.

15. The computing device of claim 13, wherein the instructions for transmitting the first request to the language model include instructions for:
generating a prompt specifying the data, the portion of text content, and a request for recommending relevant analysis and data fact templates.

16. A non-transitory computer-readable medium storing one or more programs configured for execution by one or more processors of a computing device, the one or more programs comprising instructions for:
displaying on a user interface a first visualization node and a text node, associated with one or more datasets, wherein the first visualization node is (i) upstream of the text node and (ii) includes a chart;
receiving a first user interaction with a portion of text content that is displayed in the text node;
in response to receiving the first user interaction:
retrieving, from the one or more datasets, data of the first visualization node;
transmitting to a language model a first request that includes the data and the portion of text content;
receiving from the language model a plurality of suggestions and a plurality of data visualizations for analyzing the one or more datasets, each of the suggestions corresponding to one respective data visualization; and
displaying the plurality of suggestions and their corresponding data visualizations on the user interface;
receiving user selection of a first suggestion that includes a first data visualization; and
in response to receiving the user selection:
generating and rendering a second visualization node on the user interface, including displaying the first data visualization in the second visualization node.

17. The non-transitory computer-readable medium of claim 16, the one or more programs further comprising instructions for:
after displaying the first data visualization in the second visualization node:
receiving a second user interaction with a portion of the first data visualization that is displayed in the second visualization node;
in response to receiving the second user interaction:
generating intermediate data according to the portion of the first data visualization; and
displaying the intermediate data on the user interface;
receiving, via the user interface, user selection of at least a subset of the intermediate data; and
in response to receiving the user selection:
transmitting to the language model a second request based on the user selection of the at least the subset of the intermediate data; and
receiving, from the language model, data describing the one or more datasets according to the user selection of the at least the subset of the intermediate data; and
rendering the data as an update to the text node.

18. The non-transitory computer-readable medium of claim 17, wherein the data is a text narrative.

19. The non-transitory computer-readable medium of claim 17, the one or more programs further comprising instructions for:
in response to receiving the second user interaction with the portion of the first data visualization that is displayed in the second visualization node, retrieving interaction metadata corresponding to the second user interaction, including:
starting and ending coordinates of the chart specified by the second user interaction; or
starting and ending data values of the chart specified by the second user interaction; or
starting and ending date/times of the chart specified by the second user interaction; or
data points or data ranges specified by the second user interaction.

20. The non-transitory computer-readable medium of claim 16, the one or more programs further comprising instructions for displaying, in the text node, a plurality of affordances for modifying the text content that is displayed in the text node, wherein the plurality of affordances includes one or more of:
a first affordance that, when selected by a user, summarizes the text content;
a second affordance that, when selected by the user, expands the text content; and
a third affordance that, when selected by the user, re-generates the text content.
